(19) United States
(12) Patent Application Publication
(10) Pub. No.: US 2026/0106961 A1
(43) Pub. Date: Apr. 16, 2026

(54) IMAGE CAPTURING SYSTEM, CONTROL METHOD FOR IMAGE CAPTURING SYSTEM, AND STORAGE MEDIUM

(71) Applicant: CANON KABUSHIKI KAISHA, Tokyo (JP)

(72) Inventor: HIROKI OKINO, Tokyo (JP)

(21) Appl. No.: 19/332,838

(22) Filed: Sep. 18, 2025

(30) Foreign Application Priority Data
Oct. 10, 2024 (JP) 2024-177658

(51) Int. Cl. H04N 13/296; H04N 13/246; H04N 13/275

(52) U.S. Cl. CPC H04N 13/296; H04N 13/246; H04N 13/275

(57) ABSTRACT

An image capturing system includes at least one memory storing instructions; and at least one processor executing the stored instructions causing the image capturing system to generate a first background image according to a position posture of an image capturing apparatus during a first timing; and generate a second background image corresponding to the first background image; wherein the image capturing apparatus performs image capturing during a second timing during which the first background image is displayed on a display apparatus; wherein the processor further executes the stored instructions causing the image capturing system to generate the second background image based on the position posture of the image capturing apparatus during the first timing and a position posture of the image capturing apparatus during the second timing.

### BACKGROUND

### Field of the Invention

The present disclosure relates to an image capturing system, a control method for an image capturing system, and a storage medium.

### Description of the Related Art

A technology exists in which in order to obtain an image of a subject that has a CG (computer graphics image) as the background, captured images with CG images as the background are acquired without synthesizing background images and images of the subject, by image capturing the subject by making an image that has been displayed on a display apparatus the background. Japanese Unexamined Patent Application, First Publication No. 2023-118468 discloses that VFX (Visual Effects) video images are directly acquired by performing image capturing with a display apparatus as the background in a state in which a background image that has been rendered according to a position posture of the image capturing apparatus has been output to the display apparatus.

In addition, in a case in which subjects are image captured by making images that have been displayed on a display apparatus the background, there are cases in which it is necessary to supplement the captured images due to causes such as interruptions occurring in the background image in the captured images according to a region that is more toward the outer side than an image display region of the display apparatus being included in the captured images. There exists a technology that in this case, generates background images separately from the captured images for supplementing the captured image such as images for use in synthesis with the captured images, and the like. Japanese Unexamined Patent Application, First Publication No. 2024-35420 discloses that CG images such as background images and the like are synthesized in regions of captured images corresponding to regions that are more toward the outer side than the image display region of the display apparatus.

However, according to the prior art technology, there is a possibility that discrepancies in position will occur between the captured images and the background images due to causes such as changes in the position posture of the image capturing apparatus according to the passage of time, and the like.

### SUMMARY

The present disclosure aims to suppress discrepancies in the position of a captured image and background image that occur in a case in which generation of a captured image in which the background has been made an image that has been displayed on a display apparatus is performed, and generation of a background image to supplement the captured image is performed.

In order to solve the above-described problem, in an image capturing system of the present disclosure that is configured to perform image capturing in which an image that has been displayed on a display apparatus is made a background, the image capturing system includes at least one memory storing instructions; and at least one processor executing the stored instructions causing the image capturing system to generate a first background image according to a position posture of an image capturing apparatus during a first timing; and generate a second background image corresponding to the first background image; wherein the image capturing apparatus performs image capturing during a second timing during which the first background image is displayed on a display apparatus; wherein the processor further executes the stored instructions causing the image capturing system to generate the second background image based on the position posture of the image capturing apparatus during the first timing and a position posture of the image capturing apparatus during the second timing.

Features of the present disclosure will become apparent from the following description of embodiments with reference to the attached drawings. The following description of embodiments is described by way of example.

### BRIEF DESCRIPTION OF THE DRAWINGS

FIG. 1 is a complete configuration diagram of the image capturing system.

FIG. 2 is a diagram showing an example of a hardware configuration and a functional configuration of a camera.

FIG. 3 is a diagram showing an example of a hardware configuration and a functional configuration of a system control apparatus.

FIG. 4 is a diagram showing an example of a hardware configuration and a functional configuration of a synthesis image generating apparatus.

FIG. 5 is a sequence diagram of a flow from when the system control apparatus makes a notification of the start of processing necessary for image capturing of an in-camera VFX image, until information necessary for the generation of a synthesis-use background image has been collected.

FIG. 6 is a flowchart showing a flow for image capturing processing.

FIG. 7 is a diagram showing a relationship between a camera with a position posture that was shown in previous position posture information and that is at a focal distance shown in a previous camera parameter, and an image display surface on the display apparatus.

FIG. 8 is a flowchart showing a flow of synthesis processing.

FIG. 9A and FIG. 9 B are diagrams showing image display surfaces on a world coordinate system for the image capturing system.

FIG. 10 is a diagram showing contents of an alpha blend of the captured image and the synthesis-use background image that is performed on the captured image corresponding to one from among the in-camera VFX video image.

FIG. 11A is a diagram showing the relationship between a captured image and a synthesis region to serve as a variant 1, and FIG. 11B is a magnified diagram of a region of the captured image.

FIG. 12 is a flowchart showing a flow of synthesis processing to serve as a second variant.

### DESCRIPTION OF THE EMBODIMENTS

Below, embodiments of the present disclosure will be explained with reference to the diagrams. Note that the following embodiments do not limit the inventions according to the claims. In addition, although a plurality of features are described in the embodiments, all of these features are not necessarily indispensable elements of the invention, and in addition, the plurality of features may also be selectively combined. Furthermore, in the attached figures, configurations that are identical or similar have been given the same reference numerals, and redundant descriptions will be omitted.

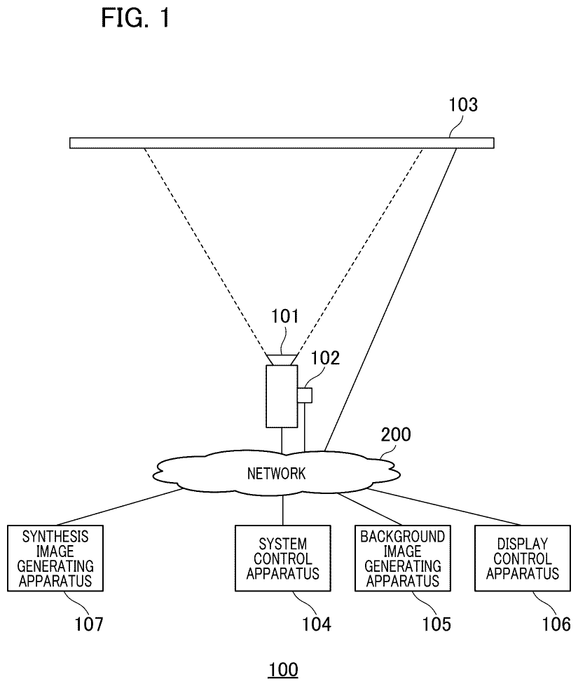

FIG. 1 is an overall configurational diagram of an image capturing system 100. The image capturing system 100 of the present embodiment is a system that captures images of a subject in which a CG image has been made the background as a virtual studio. Specifically, the image capturing system 100 captures images of a so-called in-camera VFX video image by performing image capturing by including a subject that is positioned in the foreground of a display apparatus and the display apparatus in the angle of view in a state in which a video image according to the position posture of the camera has been displayed on the display apparatus to serve as the background. In addition, the image capturing system 100 generates an image for supplementing the captured image, which is the in-camera VFX video image, and synthesizes the generated image with the captured image. As the image that supplements the video image, for example, a background image for supplementing interruptions in the background image in the captured image in a case in which interruptions in the background image in the captured image occur according to the inclusion in the captured image of a region that is more toward the outer side than the image display region of the display image, and the like are given as examples.

The image capturing system 100 is provided with a camera 101, a position posture detecting apparatus 102, a display apparatus 103, a system control apparatus 104, a background image generating apparatus 105, a display control apparatus 106, and a synthesis image generating apparatus 107. The camera 101, the position posture detecting apparatus 102, the display apparatus 103, the system control apparatus 104, the background image generating apparatus 105, the display control apparatus 106, and the synthesis image generating apparatus 107 are connected via a network 200.

The camera 101, which is one example of an image capturing apparatus, generates captured images by image capturing. The camera 101 transmits captured images that have been captured with the display apparatus 103 as the background to the synthesis image generating apparatus 107. The position posture detecting apparatus 102 is attached to the camera 101, and detects the position posture of the camera 101. The position posture detecting apparatus 102 transmits information showing the position posture for the camera 101 that has been detected to the system control apparatus 104. Note that there are cases below in which the information showing the position posture of the camera 101 that has been detected by the position posture detecting apparatus 102 will be referred to as position posture information. As the position posture information, there is, for example, information showing a rotation amount and a translation movement amount (6DoF) in relation to each of an x axis, a y axis, and a z axis of a world coordinate system. However, the position posture information may be any information as long as it is information that makes it possible to convert the world coordinate system and the camera coordinate system. For example, the position posture detecting apparatus 102 may also have a camera that is not shown, and the position posture of the camera 101 may also be detected from the positional relationship with the camera 101 of markers that are shown in a fixed position in this camera and markers that are included in the captured image that has been obtained by image capturing by the camera 101. However, the method for detecting the position posture of the camera 101 by the position posture detecting apparatus 102 may also be any method.

The display apparatus 103 is a large image display apparatus such as an LED wall, and the like. Note that the display apparatus 103 may also be configured by a plurality of display panels. The system control apparatus 104 controls the camera 101, the position posture detection apparatus 102, the background image generating apparatus 105, and the display control apparatus 106. In addition, the system control apparatus 104 transmits a synchronization signal to each apparatus that is a target of the control, and realizes synchronization of the operations of each apparatus using a method such as generator locking that controls the operation timing of each apparatus to a timing according to a reference clock that is included in the synchronization signal. As the synchronization of the operations for each apparatus, synchronization of the exposure timing for the camera 101 and the image display timing for the display apparatus 103, and the like are given as examples. In addition, the system control apparatus 104 controls the start and end of image capturing of the in-camera VFX video image. In addition, the system control apparatus 104 transmits the position posture information to the background image generating apparatus 105.

The background image generating apparatus 105, which is one example of a first generating unit, renders a 3-dimensional mode of a virtual space that has been set in advance according to the position posture of the camera 101 and generates a CG image at a predetermined frame rate to serve as a background image. The background image that is generated by the background image generating apparatus 105 is an image that is used in the display on the display apparatus 103. Therefore, there are cases below in which the background image that is generated by the background image generating apparatus 105 to serve as the image that is used in the display on the display apparatus 103 is referred to as a display-use background image. Note that there are cases below in which the camera for the virtual space is referred to as a virtual camera. In addition, the background image generating apparatus 105 applies coordinate conversion (variation processing) that is necessary in order to display the display-use background image on the display apparatus 103 in a case in which the image capturing direction of the camera 101 is not directly facing the display apparatus 103. In addition, the background image generating apparatus 105 transmits the display-use background image that has been generated to the display control apparatus 106. Note that the display-use background image is one example of a first background image.

The display control apparatus 106, which is one example of a display control unit, displays the display-use background image that was generated by the background image generating apparatus 105 on the display apparatus 103 in accordance with an image capturing timing of the camera 101. Note that in a case in which the display apparatus 103 is configured from a plurality of display panels, the display control apparatus 106 displays the display-use background image after having segmented the display-use background image to match the individual panels that configure the display apparatus 103.

The synthesis image generating apparatus 107, which is one example of a second generating unit, generates an image for supplementing the in-camera VFX video image, that is, a background image for being synthesized with the in-camera VFX video image, and synthesizes the background image that has been generated with the in-camera VFX video image. Note that below, there are cases in which the background image that the synthesis image generating apparatus 107 generates in order to synthesize with the in-camera VFX video image is referred to as a synthesis-use background image. The synthesis image generating apparatus 107 generates a synthesis-use background image after the completion of the image capturing for the in-camera VFX video image. Note that the synthesis-use background image is one example of a second background image. In addition, the synthesis-use background image can also be understood as an image that corresponds to the display-use background image. The synthesis image generating apparatus 107 renders a 3-dimensional model of the virtual space that has been set in advance according to a predetermined position posture in the same manner as the background image generating apparatus 105. In addition, the synthesis image generating apparatus 107 generates the synthesis-use background image by executing each type of image processing including perspective projection conversion processing on the image that has been generated by the rendering. Furthermore, the synthesis image generating apparatus 107 synthesizes the synthesis-use background image with a region that has been determined to be a target for supplementation from among the captured image that serves as the in-camera VFX video image. Note that there are cases below in which the image in which the synthesis-use background image has been synthesized with the image capturing image is referred to as a synthesized image.

The system control apparatus 104, the background image generating apparatus 105, the display control apparatus 106, and the synthesis image generating apparatus 107 are, for example, computers. The system control apparatus 104, the background image synthesis apparatus 105, the display control apparatus 106, and the synthesis image generating apparatus 107 may be configured by a single computer, or they may also be realized by a plurality of computers using distributed processing. In addition, in a case in which the system control apparatus 104, the background image generating apparatus 105, the display control apparatus 106, and the synthesis image generating apparatus 107 are realized by a plurality of computers using distributed processing, the combination of apparatuses per each computer may be any combination of apparatuses.

The network 200 is realized by, for example, a LAN (local area network), and a WAN (Wide Area Network), such as the internet, and the like. In addition, the network 200 may also be realized by any of a phone line, a digital leased line, an ATM (Asynchronous Transfer Mode) frame relay line, a cable television line, and a data transmission wireless line, and the like, and a combination thereof, instead of the internet.

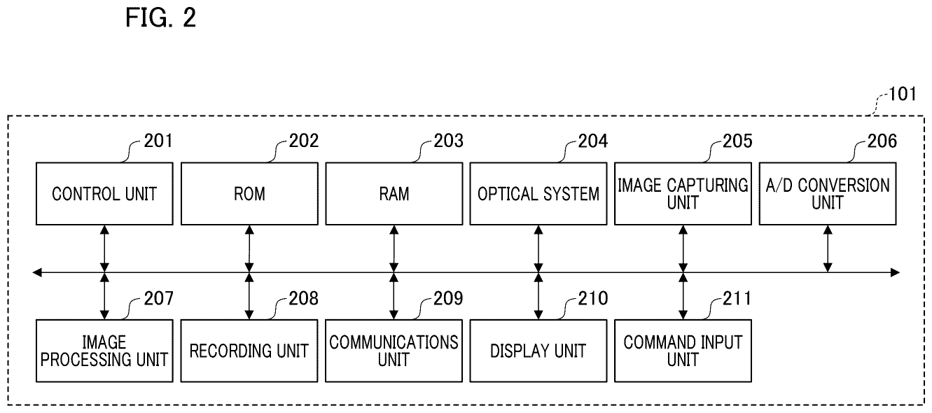

FIG. 2 is a diagram showing an example of a hardware configuration and a functional configuration of the camera 101. The camera 101 has a control unit 201, a ROM 202, a RAM 203, an optical system 204, an image capturing unit 205, an A/D conversion unit 206, an image processing unit 207, a recording unit 208, a communications unit 209, a display unit 210, and a command input unit 211. The control unit 201, the ROM 202, the RAM 203, the optical system 204, the image capturing unit 205, the A/D conversion unit 206, the image processing unit 207, the recording unit 208, the communications unit 209, the display unit 210, and the command input unit 211 are all connected via a bus.

The control unit 201 is, for example, a CPU, and controls the entirety of the camera 101. More specifically, the control unit 201 controls the operations of each functional unit of the camera 101 by reading out a control program from the ROM 202, and expanding and executing this control program on the RAM 203. In addition, the control unit 201 synchronizes the operations of the camera 101 to the operations of the external apparatus by controlling the operations of each functional unit in the camera 101 based on a synchronization signal that has been supplied by the communications unit 209. Note that instead of a CPU, a GPU may also be used in the camera 110 to serve as the control unit 201. The ROM 202 is a nonvolatile memory that is capable of electronic deletion and recording, and stores operation programs for each functional unit of the camera 101, as well as the parameters that are necessary for the operations in each of the functional units of the camera 101, and the like. The RAM 203 is a re-writable volatile memory, and is used as a temporary storage for the expansion of programs that are executed by the control unit 201, and data that has been generated by the operations of each functional unit of the camera 101. The optical system 204 is configured by a lens group including a zoom lens, and a focus lens, and forms images of a subject image on an image capturing surface of the image capturing unit 205. The image capturing unit 205 is for example, an image capturing element such as a CCD sensor, a CMOS sensor, and the like, photoelectrically converts the optical image that has been formed on the image capturing surface of the image capturing unit 205 by the optical system 204, and outputs the analogue image signal that has been obtained to the A/D conversion unit 206. The A/D conversion unit 206 converts the analogue image signal that has been input into digital image data. The digital image data that has been output from the A/D conversion unit 206 is temporarily stored in the RAM 203. The image processing unit 207 performs each type of image processing on the images that are stored in the RAM 203. As the image processing by the image processing unit 207, for example, processing that is necessary for the development, display, and recording of images such as de-mosaic processing, white balance correction processing, gamma processing, and the like are given as examples. In addition, the image processing unit 207 performs processing that is necessary to enhance image quality such as noise suppressing processing for noise due to space filtering and the synthesis of a plurality of images, and the like. The recording unit 208, which is one example of a recording unit, records information such as images and the like on the internal recording medium. The communications unit 209 connects to the external apparatus by a wired or wireless connection, transmits images, and receives the synchronization signal. The display unit 210 includes a display device such as an LCD and the like, and displays images that are stored in the RAM 203, and images that are recorded in the recording unit 208 on the display device. In addition, the display unit 210 performs the display of a user interface for receiving commands from a user, and the like. The command input unit 211 is an interface for receiving inputs of commands by the user. The command input unit 211 also includes a physical operating member such as a touch panel, a shutter button, and the like.

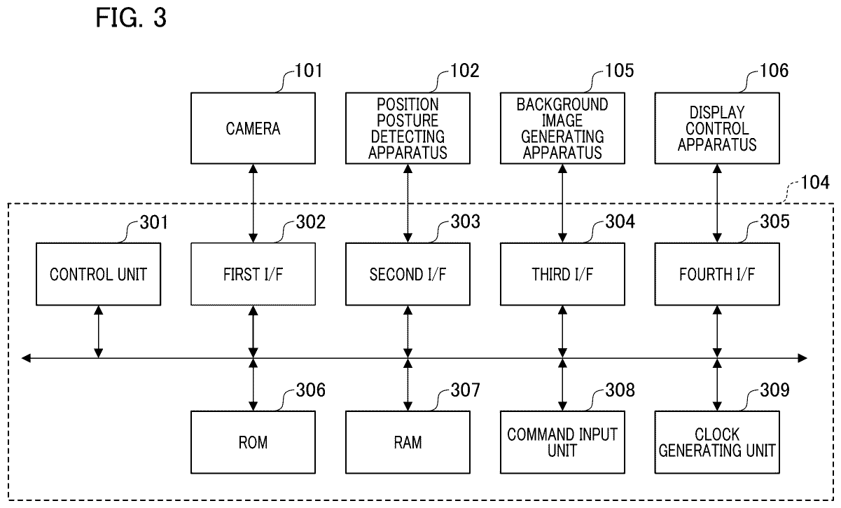

FIG. 3 is a diagram showing an example of a hardware configuration and a functional configuration of the system control apparatus 104. The system control apparatus 104 has a control unit 301, a first I/F 302, a second I/F 303, a third I/F 304, a fourth I/F 305, a ROM 306, a RAM 307, a command input unit 308, and a clock generating unit 309. The control unit 301, the first I/F 302, the second I/F 303, the third I/F 304, the fourth I/F 305, the ROM 306, the RAM 307, the command input unit 308, and the clock generating unit 309 are all connected via a bus. The control unit 301 is for example, a CPU, and controls the entirety of the system control apparatus 104. More specifically, the control unit 301 controls the operations of each of the functional units of the system control apparatus 104 by reading out a control program from the ROM 306 and expanding then executing this on the RAM 307. In addition, the control unit 301 controls the operations timing of the system control apparatus 104 according to the synchronization signal that is supplied from the clock generating unit 309.

The first I/F 302 is an interface that is used in communications with the camera 101. The second I/F 303 is an interface that is used in communications with the position posture detection apparatus 102. The third I/F 304 is an interface that is used in communications with the background image generating apparatus 105. The fourth I/F 305 is an interface that is used in communications with the display control apparatus 106. Note that the first I/F 302, the second I/F 303, the third I/F 304, and the fourth I/F 305 all communicate according to standards corresponding to the external apparatus with which they are connected and the type of signals that they are transmitting and receiving. In addition, a plurality of interfaces may also be used in the communications between the system control apparatus 104 and the external apparatus.

The ROM 306 stores programs that are executed by the control unit 301, settings values for the system control apparatus 104, and the like. As the programs that are executed by the control unit 301, examples are given of, for example, a BIOS, a boot strap loader, firmware, and the like. The RAM 307 is a re-writable volatile memory, and is used in the expansion of the programs that are executed by the control unit 301, the temporary storage of information that has been generated by operations of each of the functional units of the system control apparatus 104, and the like. The command input unit 308 is an input device for receiving the inputs of commands by the user. As the command input unit 808, for example, a keyboard, a mouse, a touch pad, and the like are given as examples. The clock generating unit 309 generates a synchronizing signal (clock) for synchronizing the operations of the system control apparatus 104, the operations of the camera 101, the operations of the position posture detecting apparatus 102, the operations of the background image generating apparatus 105, and the operations of the display control apparatus 106 with each other.

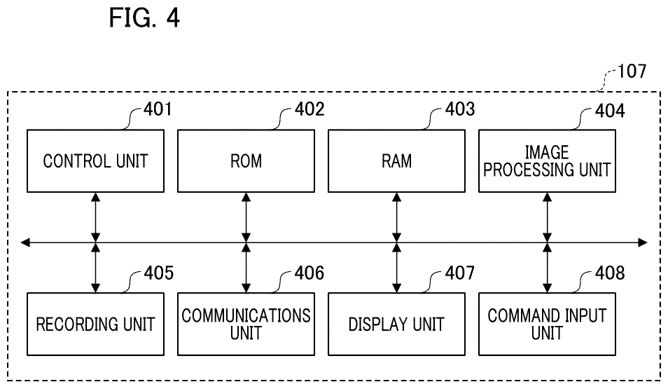

FIG. 4 is a block diagram showing an example of the hardware configuration and the functional configuration of the synthesis image generating apparatus 107. The synthesis image generating apparatus 107 has a control unit 401, a ROM 402, a RAM 403, an image processing unit 404, a recording unit 405, a communications unit 406, a display unit 407, and a command input unit 408. The control unit 401, the ROM 402, the RAM 403, the image processing unit 404, the recording unit 405, the communications unit 406, the display unit 407, and the command input unit 408 are all connected via a bus. The control unit 401 is, for example, a CPU, and controls the entirety of the synthesis image generating apparatus 107. More specifically, the control unit 401 controls the operations of all of the functional units of the synthesis image generating apparatus 107 by reading out a control program from the ROM 402 and expanding and executing this on the RAM 403. Note that in the synthesis image generating apparatus 107, a GPU may also be used as the control unit 401 instead of a CPU. The ROM 402 stores programs that are executed by the control unit 401, settings values for the synthesis image generating apparatus 107, and the like. For example, a BIOS, a boot strap loader, firmware, and the like are given as examples of the programs that are executed by the control unit 401. The RAM 403 is a re-writable volatile memory, and is used in the expansion of the programs that are executed by the control unit 401, the temporary storage of information that has been generated by operations of each of the functional units of the synthesis image generating unit 107, and the like. In addition, the RAM 403 also stores a 3-dimensional model of the virtual space. The image processing unit 404 renders a 3-dimensional model of the virtual space that is stored in the RAM 403. In addition, the image processing unit 404 performs each type of image processing on the images that are stored in the RAM 403. For example, correction processing for the image for synthesis with the in-camera VFX video image such as perspective projection conversion processing, and the like, are given as examples of the image processing that the image processing unit 404 performs on the images. In addition, for example, synthesis processing for a plurality of images, and the like are given as examples of the image processing that the image processing unit 404 performs on the images. The recording unit 405 records information that includes images on the internal storage medium. The communications unit 406 connects with the external apparatus through a wired or wireless connection and performs the transmission and reception of information such as images and the like. The display unit 407 includes display devices such as LCDs, and the like, and displays images that are stored on the RAM 403 and the recording unit 405 on the display device. In addition, the display unit 407 also performs display and the like of a user interface for receiving commands from the user. The command input unit 408 is an input device for receiving inputs of commands from users. For example, a keyboard, a mouse, a touch pad, and the like are given as examples of the command input unit 408.

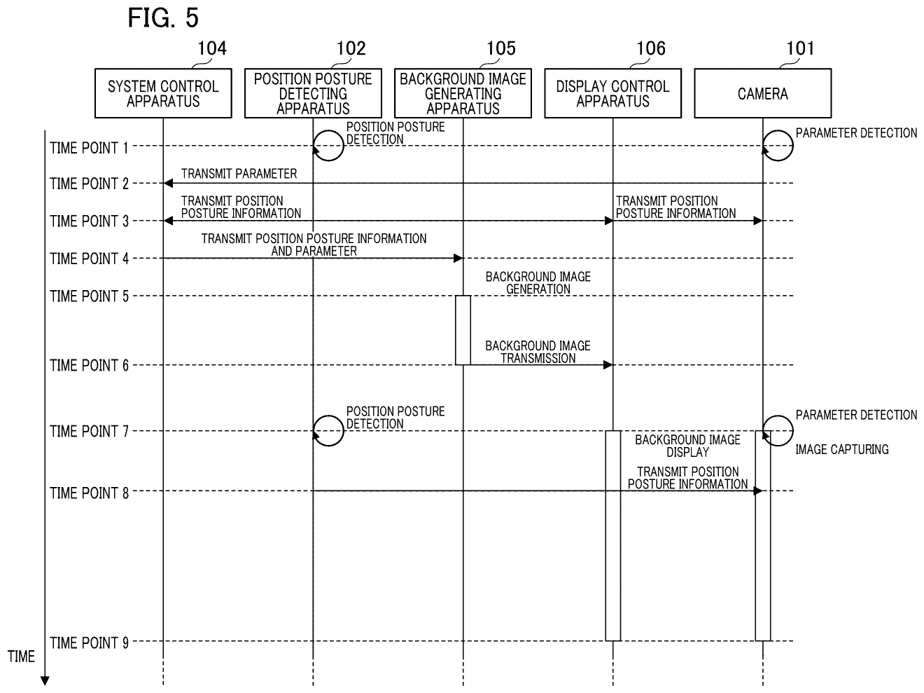

FIG. 5 is a sequence diagram of a flow from when the system control apparatus 104 makes a notification of the start of processing necessary for image capturing of an in-camera VFX image, until information necessary for the generation of a synthesis-use background image has been collected. Note that the apparatuses that are the destinations for the notification of the start of the processing by the system control apparatus 104 are the camera 101, the position posture detecting apparatus 102, the background image generating apparatus 105, and the display control apparatus 106. In addition, the system control apparatus 104 controls the timing of the operations in each of the notification destination apparatuses by notifying these apparatuses of the start of processing as well as transmitting a synchronization signal to each of the notification destination apparatuses.

As is shown in FIG. 5 during a time point 1, the position posture detecting apparatus 102 detects the position posture of the camera 101, and generates position posture information according to the detection results. Although the details of this will be described below, the position posture detecting apparatus 102 detects the position posture of the camera 101 again and generates the position posture according to the detection results again at another timing after this time period 1. Therefore, there are cases below in which the position posture that is generated by the detection during the time point 1 will be referred to as a previous position posture. In addition, during the time point 1, the camera 101 detects a parameter of the camera 101. Note that there are cases below in which the parameter of the camera is referred to below as the camera parameter. For example, parameters relating to the optical characteristics of the camera 101 are given as examples of the camera parameter that has been detected during the time period 1. In addition, the focal distance of the camera 101 is also given as an example of the parameter relating to the optical properties of the camera 101. Note that although it will be described below, the camera 101 detects the parameter of the camera 101 again at a timing that comes after this time point 1. Therefore, there are cases below in which the camera parameter that was detected during the time point 1 is referred to as a previous camera parameter. The camera 101 stores the previous camera parameter on the RAM 203. In this manner, in the present embodiment, the detection timing for the position posture of the camera according to the previous position posture information by the position posture detecting apparatus 102, and the detection timing of the previous camera parameter by the camera 101 match the time point 1. Note that the time point 1 is one example of a first timing.

Next, during a time point 2, which is a later timing than the time point 1, the control unit 201 of the camera 101 transmits the previous camera parameter that was detected during the time point 1 to the system control apparatus 104. The RAM 307 of the system control apparatus 104 stores the previous camera parameter that has been received. Next, during a time point 3, which is a time point that is later than the time point 2, the position posture detecting apparatus 102 transmits the previous position posture information that was generated by detection during the time point 1 to the camera 101 and the system control apparatus 104. The RAM 203 of the camera 101 and the RAM 307 of the system control apparatus 104 record the previous position posture information that has been received. Note that the order of the timing at which the camera transmits the previous camera parameter and the timing at which the position posture detecting apparatus 102 transmits the position posture information may be reversed, or these may also be the same timing.

Next, during a time point 4, which is a timing that is later than the time point 3, the control unit 301 of the system control apparatus 104 transmits the previous camera parameter that was received during the time point 2, and the previous position posture information that was received during the time point 3 to the background image generating apparatus 105. The background image generating apparatus 105 records the previous camera parameter and the previous position posture that have been received. Note that the camera 101 may also transmit the previous camera parameter to the background image generating apparatus 105 instead of to the system control apparatus 104. In addition, the position posture detecting apparatus 102 may also transmit the previous position posture information to the background image generating apparatus 105 instead of to the system control apparatus 104.

Next, during a time point 5, which is a timing that is later than the time point 4, the background image generating apparatus 105 starts the generation of the display-use background image based on the previous camera parameter and the previous position posture that were received during the time point 4. Note that the method for the generation of the display-use background image by the display-use background image generating apparatus 105 will be described below. Next, during a time point 6, which is a timing that is later than the time point 5, the background image generating apparatus 105 transmits the display-use background image that was generated by starting the generation during the time point 5 to the display control apparatus 106.

Next, during a time point 7, which is a timing that is later than the time point 6, the display control apparatus 106 begins the display on the display apparatus 103 of the display-use background image that was received from the background image generating apparatus 105 during the time point 6 by outputting the display-use background image to the display apparatus 103. In addition, during the time point 7, the camera 101 begins image capturing of the subject including the display apparatus 103. In other words, the camera 101 begins image capturing of the subject including the display-use background image that has been displayed on the display apparatus 103. In addition, during the time point 7, the position posture detecting apparatus 102 detects the position posture of the camera 101, and generates position posture information according to the detection results. The position posture information that has been generated by the detection during the time point 7 is position posture information that has been generated by a detection during a timing that is later than the timing for the previous position posture information. Therefore, there are cases below in which the position posture information that is generated by the detection during the time point 7 is referred to as the later position posture information. In addition, during the time point 7, the camera 101 detects the camera parameter. The camera parameter that has been detected during the time point 7 is a camera parameter that has been detected at a timing that is later than the timing for the previous camera parameter. Therefore, there are cases below in which the camera parameter that has been detected during the time point 7 is referred to as the later camera parameter. In addition, the previous camera parameter and the later camera parameter are the same type of parameter. The camera 101 stores the later parameter on the RAM 203. In this manner, during the present embodiment, the timing at which the display of the display-use background image on the display apparatus 103 begins, the timing at which image capturing by the camera 101 begins, the timing of the detection by the position posture detection apparatus 102, and the timing of the detection by the camera 101 all correspond to the time point 7. Note that the time point 7 is one example of a second timing.

Next, during a time point 8, which is a timing that is later than the time point 7, the position posture detecting apparatus 102 transmits the later position posture information that was generated by the detection during the time point 7 to the camera 101. The RAM 203 of the camera 101 stores the later position posture information that has been received. In addition, the display of the display-use background image by the display apparatus 103 and the image capturing by the camera 101 that were begun during the time point 7 are performed until a time point 9, which is a timing that is later than the time point 8. In addition, during the time point 9 and after, the processing from the time point 1 to the time point 8 is repeated until the system control apparatus 104 gives a command to complete the processing. In this case, the display control apparatus 106 displays a newly generated display-use background image on the display apparatus 103 every time that a new display-use background image is generated by the background image generating apparatus 105. The display contents of the display apparatus 103, which are the display-use background image that is image captured by the camera 101, are thereby updated. In this manner, the image capturing system 100 captures the in-camera VFX video image. In addition, the camera 101 acquires the captured image that serves as the in-camera VFX video image, the previous camera parameter, the previous position posture information, the later camera parameter, and the later position posture information.

Note that the relationship between each time period from the time point 2 to the time point 8 is not limited to the example shown in the figures. For example, the time period from the time point 5 until the time point 7 may also be made longer than the time period from the time point 1 until the time point 5. In addition, the time period from the time point 7 until the time point 9 may also be made longer than the time period from the time point 1 until the time point 5, and the time period from the time point 5 until the time point 7.

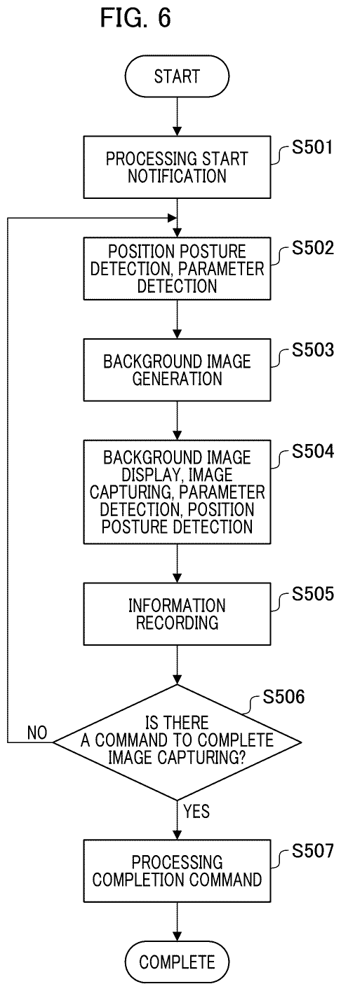

FIG. 6 is a flowchart showing the flow for the image capturing processing. The image capturing processing is processing for the image capturing system 100 to capture the in-camera VFX image. In the present embodiment, the image capturing processing begins when the user inputs a command to begin the image capturing of the in-camera VFX video image into the command input unit 308 of the system control apparatus 104. The system control apparatus 104 notifies the camera 101, the position posture detecting apparatus 102, the background image generating apparatus 105, and the display control apparatus 106 of the beginning of processing that is necessary for image capturing of the in-camera VFX video image, and begins the image capturing sequence for the in-camera VFX video image (S501). In addition, at this time, the control unit 301 of the system control apparatus 104 transmits the synchronization signal as was explained above. The camera 101, the position posture detecting apparatus 102, the background image generating apparatus 105, and the display control apparatus 106 thereby operate at a pre-determined operation timing during the image capturing sequence.

Next, along with the position posture detecting apparatus 102 detecting the position posture of the camera 101, the camera 101 detects the camera parameter (S502). The detection during step 502 is the detection that occurs during the timing of the time point 1 shown in FIG. 5. The position posture detecting apparatus 102 transmits the previous position posture information that was generated by the detection during step 502 to the camera 101 and the system control apparatus 104. In addition, the camera 101 transmits the previous camera parameter and the previous position posture information to the background image generating apparatus 105. Next, the background image generating apparatus 105 generates a display-use background image based on the previous camera parameter and the previous position posture information (S503). The display-use background image that is generated during step S503 is a display-use background image for which the generation is begun during the timing of the time point 5 shown in FIG. 5. The background image generating apparatus 105 transmits the display-use background image that has been generated to the display control apparatus 106.

Next, the display of the display-use background image on the display apparatus 103 by the display control apparatus 106, the image capturing by the camera 101, the detection of the later camera parameter by the camera 101, and the detection of the position posture of the camera 101 by the position posture detecting apparatus 102 are performed (S504). The processing during step S504 is the processing that is executed during the time point 7 that is shown in FIG. 5. Therefore, the later position posture information is generated by the processing during step 504. The position posture detecting apparatus 102 transmits the later position posture information to the camera 101. Next, the camera 101 records the previous camera parameter, the previous position posture information, the captured image that was captured during step 504, the later camera parameter, and the later position posture information on the recording unit 208 (S505). More specifically, the recording unit 208 records a captured image in which the previous camera parameter, the previous position posture information, the later camera parameter, and the later position posture have been associated to serve as meta data.

Next, the control unit 301 of the system control apparatus 104 determines whether or not there has been a command to end the image capturing of the in-camera VFX video image (S506). In the present embodiment, the determination in step 506 is performed according to whether or not the user has input a command to end the image capturing of the in-camera VFX video image into the command input unit 308 of the system control apparatus 104. In a case in which there has been no command to end the image capturing of the in-camera VFX video image (no during S506), the processing from step 502 onward is repeated. More specifically, in a case in which there has been no command to end the image capturing of the in-camera VFX video image, the processing from step 502 to step 506 is performed for each one frame based on the synchronization signal that is provided from the clock generating unit 309 of the system control apparatus 104. One frame is one frame from among the video image that has been captured by the camera 101 at a pre-determined frame rate. Therefore, a previous camera parameter, a previous position posture information, a later camera parameter, and a later position posture information are associated with each frame of the captured image that is generated by the image capturing of the camera 101 until the end of the image capturing of the in-camera VFX video image. In this case, it becomes easy to identify the position posture information and the camera parameters corresponding to the captured images for each frame.

In addition, in a case in which there has been a command to end the image capturing of the in-camera VFX (yes during $506), the processing proceeds to the next step. The system control apparatus 104 transmits a command to the camera 101, the position posture detecting apparatus 102, the background image generating apparatus 105, and the display control apparatus 106 to end the processing that is necessary for the image capturing of the in-camera VFX video image, and completes the image capturing sequence for the in-camera VFX video image (S507).

As has been explained above, the processing for the image processing for step 502 to step 506 is performed per one frame. Therefore, the time period from the time point 1 to the time point 7 that is shown in FIG. 5 is a time period that is less than one frame. In other words, the time period from the detection of the position posture according to the previous position posture information until the detection of the position posture according to the later position posture information by the position posture detecting apparatus 102 is a time period that is less than one frame. In addition, the time period from the detection of the position posture information according to the previous position posture information by the position posture detecting apparatus 102 until the beginning of the image capturing of the in-camera VFX video image by the camera 101 is less than one frame.

Next, the method for generating the display-use background image by the background image generating apparatus 105 will be explained. The background image generating apparatus 105 first sets the position posture of the virtual camera according to the previous position posture information, and sets the camera parameter for the virtual camera according to the previous camera parameter. At this time, the camera parameter of the virtual camera that is set is the same type of camera parameter as the previous camera parameter. In addition, the background image generating apparatus 105 generates a CG image by rendering a 3-dimensional model of the virtual space according to the position posture and camera parameter for the virtual camera that have been set. Below, there are cases in which the CG image that is generated by the background image generating apparatus 105 performing rendering is referred to as a background rendering image. Next, the background image generating apparatus 105 corrects the background rendering image. In a case in which the camera 101, which has the position posture indicated by the previous position posture information, has performed image capturing by including the display-use background image that is displayed on the display apparatus 103 in the angle of view, the correction of the background rendering image is performed with the goal of correcting distortion, and changes in the magnification of the display-use background image within the captured image. The background image generating apparatus 105 generates the display-use background image through this correction.

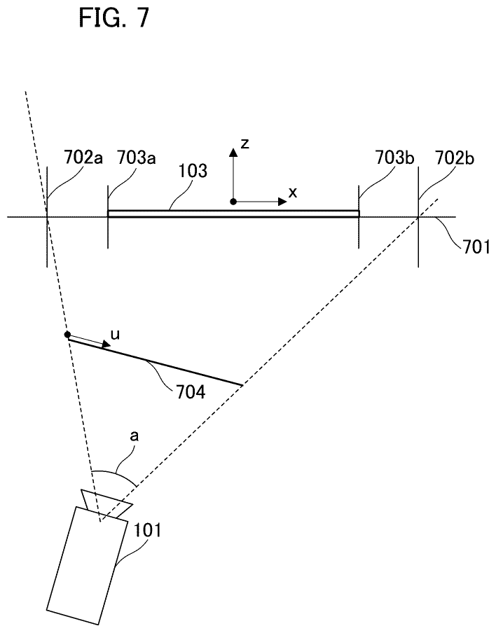

FIG. 7 is a diagram showing the relationship between the camera 101, which has the position posture shown by the previous position posture information, and a focal distance shown by the previous camera parameter, and an image display surface on the display apparatus 103. Below, the corrections to the background rendering image by the background image generating apparatus 105 will be explained using FIG. 7. First, the configuration shown in FIG. 7 will be explained. The image display surface on the display apparatus 103 is a surface on the camera 101 side as well as a level surface. In addition, the example shown in the figures is a state in which the camera 101 is not directly facing the image display surface of the display apparatus 103. In addition, FIG. 7 shows the x axis and the z axis from among the world coordinate system that is represented by the three dimensions of the x axis, the y axis, and the z axis, as well as showing a u axis from among the camera coordinate system that is represented by the two dimensions of the u axis and the v axis. In the example shown in the figures, the x axis is the direction that is parallel to the image display surface in the display apparatus 103 and the ground, and the z axis is the direction that is perpendicular to the image display surface in the display apparatus 103. In addition, in the example shown in the figures, the u axis is an arbitrary direction of the captured image that is captured by the camera 101, that is, a horizontal direction of the captured image that is captured by the camera 101. In addition, the region that is enclosed by the two dotted lines is the region that is included in an angle of view a of the camera 101. In addition, the plane 701 represents the virtual image display surface that includes the image display surface of the display apparatus 103, which is in a fixed position. In addition, from among the plane 701, the portion from the segmenting line 702a to the segmenting line 702b, is the range that is included in the angle of view of the camera 101, that is, the image capturing range of the camera 101. In addition, from among the plane 701, the portion from the segmenting line 703a to the segmenting line 703b is the range of the image display surface on the display apparatus 103. In addition, the image plane 704 is an image plane of the camera 101. In addition, the plane 701 shows a virtual image display surface that includes the image display surface of the display apparatus 103 for which the position is already known. The display apparatus 103, for which the position is already known, means that the position information showing the position of the display apparatus 103 is already known in the image capturing system 100.

If the camera 101 performs image capturing such that the entire surface of the background rendering image is allocated across the entire surface of the image plane 704, then the position posture and the camera parameter of the camera 101 conform with the image that is shown in the captured image that serves as the display-use background image that is displayed by the display apparatus 103. In addition, if the background rendering image is corrected such that the portion from the segmenting line 702a until the segmenting line 702b from among the plane 701 is allocated to the display-used background image, the entire surface of the display-use background image will be image captured by the camera 101 so as to be allocated to the entire surface of the image plane 704.

The background image generating apparatus 105 uses the formula for perspective projection conversion processing that is shown in the following Formula (1) based on the previous camera parameter and the previous position posture information, and corrects the background rendering image.

$$\begin{matrix}[ Formula 1 ] & \\ {Z}_{c 1} [ \begin{matrix}{u}_{c 1} \\ {v}_{c 1} \\ 1\end{matrix} ] = {A}_{c 1} ( {R}_{c 1} [ \begin{matrix}{X}_{w} \\ {Y}_{w} \\ {Z}_{w}\end{matrix} ] + {T}_{c 1} ) & ( 1 )\end{matrix}$$

In the Formula (1), X_{w} shows the coordinates for the x axis in the world coordinate system, Y_{w} shows the coordinates for the y axis in the world coordinate system, and Z_{w} shows the coordinates for the z axis in the world coordinate system, and these include each coordinate of the image display surface in the display apparatus 103. In addition, U_{c1}, and V_{c1} of the Formula (1) represent coordinates for the captured image in a case in which the captured image has been captured by the camera 101 with the previous camera parameter and the position posture represented by the previous position posture information. Note that a case in which image capturing is performed by the camera 101 with the previous camera parameter and the position posture that is represented by the previous position posture information means a case in which image capturing is performed by the camera 101 with the camera parameter and position posture from the time point 1 shown in FIG. 5.

In addition, in the Formula (1), R_{c1} is the rotational angle of the camera 101 during the time point 1 in relation to the x axis, the y axis, and z axis in the world coordinate system, and T_{c1} is the translation movement amount for the camera 101 during the time point 1 shown in FIG. 5 in relation to the x axis, the y axis, and the z axis in the world coordinate system. R_{c1} in the Formula (1) is found using the following Formula (2), and T_{c1} in the Formula 1 is found using the following Formula (3).

$$\begin{matrix}[ Formula 2 ] & \\ {R}_{c 1} = [ \begin{matrix}{α}_{11} & {α}_{12} & {α}_{13} \\ {α}_{21} & {α}_{22} & {α}_{23} \\ {α}_{31} & {α}_{32} & {α}_{33}\end{matrix} ] & ( 2 )\end{matrix}$$

$$\begin{matrix}[ Formula 3 ] & \\ {T}_{c 1} = [ \begin{matrix}{σ}_{1} \\ {σ}_{2} \\ {σ}_{3}\end{matrix} ] & ( 3 )\end{matrix}$$

The constants in both the Formula (2), and the (Formula (3) are derived from the previous position posture information.

In addition, A_{c1} in the Formula (1) is the previous camera parameter including the focal distance of the camera 101 during the time point 1 shown in FIG. 5, as is shown in the following Formula (4).

$$\begin{matrix}[ Formula 4 ] & \\ {A}_{c 1} = [ \begin{matrix}{f}_{x} & 0 & {γ}_{x} \\ 0 & {f}_{y} & {γ}_{y} \\ 0 & 0 & 1\end{matrix} ] & ( 4 )\end{matrix}$$

Fₓ, and f_{y}, which are constants of A_{c1} that are shown in the Formula (4), are the focal distances for pixel units, and they are each derived from the focal distance of the camera 101 that is included in the previous camera parameter and the pixel pitch in the vertical and horizontal directions. In addition, rₓ, and r_{y} in the Formula 4 are constants for identifying the optical center.

In addition, Z_{c1} of the Formula (1) is a coordinate for the camera coordinate system C1 in the position posture of the camera 101 that is indicated by the previous position posture information, and corresponds to the coordinate Z_{w} of the world coordinate system. The coordinates X_{c1}, Y_{c1}, and Z_{c1} of the camera coordinate system C1, which correspond respectively to the coordinates X_{w}, Y_{w}, and Z_{w} of the world coordinate system, are derived from the following Formula (5).

$$\begin{matrix}[ Formula 5 ] & \\ [ \begin{matrix}{X}_{c 1} \\ {Y}_{c 1} \\ {Z}_{c 1}\end{matrix} ] = {R}_{c 1} [ \begin{matrix}{X}_{w} \\ {Y}_{w} \\ {Z}_{w}\end{matrix} ] + {T}_{c 1} & ( 5 )\end{matrix}$$

The background rendering image is an image in which a 3-dimensional model has been rendered according to the camera parameter and the position posture of a virtual camera that have been set based on the previous camera parameter and the previous position posture information. Therefore, the coordinates of the background rendering image can be understood to be represented by u_{c1}, and v_{c1} in the same manner as the Formula (1). With respect to the coordinates X_{wp}, Y_{wp}, and Z_{wp} for a predetermined pixel P in the image display surface of the display apparatus 103, the background image generating apparatus 105 calculates the coordinates U_{c1p}, and V_{c1p} for the background rendering image that corresponds to these coordinates from the Formula (1), and obtains the pixel values for the coordinates u_{c1p}, and v_{c1p}. In addition, the background image generating apparatus 105 sets the pixel values for the coordinates u_{c1p}, and v_{c1p} to serve as the pixel values that are displayed in the predetermined pixel P in the image display surface of the display apparatus 103. Furthermore, the background image generating apparatus 105 performs these pixel value settings for each pixel of the image display surface of the display apparatus 103. A display-use background image for which correction for distortion and magnification has been performed such that the entire surface of the background rendering image is allocated to the entire surface of the image plane 704 is thereby generated. In addition, in a case in which the camera 101 has performed image capturing during the time period 1, the coordinates for the image that is shown in the captured image that serves as the display-use background image displayed on the display apparatus 103, are represented by u_{c1}, and v_{c1} in the same manner as the for the background rendering image.

Note that in a case in which the camera 101 performs image capturing during the time point 1, there are cases in which the coordinates u_{c1p}, and v_{c1p} for the background rendering image that correspond to the coordinates X_{wp}, Y_{wp}, and Z_{wp} for the predetermined pixel P on the image display surface of the display apparatus 103 are not included in the angle of view of the camera 101. In this case, the background image generating apparatus 105 does not need to perform the allocation of the pixel values to the coordinates for the background rendering image corresponding to the coordinates of this pixel P. In addition, for example, the pixel values for a still image that is associated with the 3-dimensional mode for the virtual space that is used in the rendering may also be set in the pixel P. By doing so, the image capturing by the image capturing system 100 is performed based on a suitable light environment. In addition, below, in a case in which the camera 101 performs image capturing during the time point 1, it is made such that pixels in the image display surface of the display apparatus 103 that correspond to the coordinates of the background rendering image that are not included in the angle of view of the camera 101 do not exist.

In addition, rendering of a background rendering image that targets a region with a wider range than the angle of view of the camera 101 in a case in which the camera 101 performs image capturing during the time point 1 may also be performed by the background image generating apparatus 105. In this case, the background image generating apparatus 105 may also allocate the pixel values to the coordinates for the background rendering image with a region with a wider range than the angle of view of the camera 101 during the time point 1 as a target. By doing so, even in a case in which there has been a change in the position posture and camera parameter from the state for the camera 101 from the time point 1, image capturing of regions in which images that are different from the display-use background image are displayed from among the image display surface in the display apparatus 103 is prohibited.

Note that in the above-explained example, an explanation has been given in which the generation of the display-use background image is begun during the time point 5 shown in FIG. 5. Specifically, in this context, the time point 5 is the time point at which the generation of the background rendering image is begun. In addition, the display-use background image is generated from the beginning of the generation of the background rendering image during the time point 5 until the time point 6. That is, the generation of the background rendering image and the generation of the display-use background image are performed during the time period from the time point 5 until the time point 6.

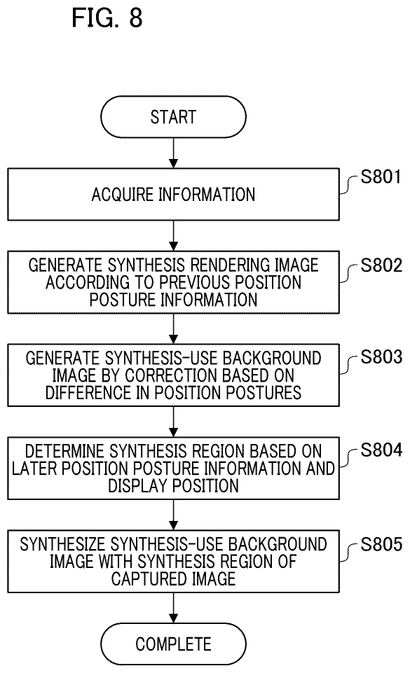

FIG. 8 is a flowchart showing a flow of synthesis processing. The synthesis processing is processing in which the synthesis image generating apparatus 107 generates a synthesis image. In the present embodiment, the synthesis processing begins when the user inputs a command for generating a synthesis image into the command input unit 408 of the synthesis image generating apparatus 107. The control unit 401 of the synthesis image generating apparatus 107 requests the captured image, the previous camera parameter, the previous position posture, the later camera parameter, and the later position posture from the camera 101 and thereby obtains the information that has been requested from the camera 101 (S801). More specifically, the control unit 401 of the synthesis image generating apparatus 107 acquires a captured image in which the previous camera parameter, the previous position posture, the later camera parameter, and the later position posture have been associated to serve as meta data. In addition, the recording unit 405 of the synthesis image generating apparatus 107 records the information that has been acquired during step 801.

The control unit 401 of the synthesis image generating apparatus 107 renders a 3-dimensional model of a virtual space that is the same as the virtual space that was used in the generation of the background rendering image by the background image generating apparatus 105 according to the previous position posture information, and generates a CG image for use in synthesis (S802). The method in which the synthesis image generating apparatus 107 generates the CG image for use in synthesis by rendering a 3-dimensional model will be explained. The synthesis image generating apparatus 107 sets a position posture of a virtual camera according to the previous position posture information along with setting the camera parameter of the virtual camera according to the previous camera parameter. The camera parameter of the virtual parameter that is set at this time is the same type of camera parameter as the previous camera parameter. In addition, the synthesis image generating apparatus 107 generates a CG image for use in synthesis by rendering a 3-dimensional model of the virtual space according to the position posture and camera parameter of the virtual camera that have been set. There are cases in which the CG image for use in synthesis that has been generated by the synthesis image generating apparatus 107 performing rendering is referred to below as the synthesis rendering image. The synthesis rendering image is an image that has been generated based on the previous camera parameter and the previous position posture information in the same manner as the display-use background image. Therefore, the synthesis rendering image can also be understood as an image that corresponds to the display-use background image.

Note that in a case of generating a background rendering image, the background image generating apparatus 105 performs rendering that is limited to the range of the image display surface of the display apparatus 103 from among the image capturing range of the camera 101. In contrast, in a case in which a synthesis rendering image is being generated, the synthesis image generating apparatus 107 performs rendering with respect to the entire surface of the image capturing range of the virtual camera. By doing so, in this case, a CG image corresponding to a region that is more toward the outer side than the image display surface of the display apparatus 103 is also included in the synthesis rendering image.

Next, the control unit 401 of the synthesis image generating apparatus 107 corrects the synthesis rendering image according to the previous position posture information and the later position posture information. More specifically, the control unit 401 generates a synthesis-use background image by correcting the rendering image based on the difference between the position posture of the camera 101 shown by the previous position posture information and the position posture of the camera 101 shown by the later position posture information (S803). Note that the method for generation of the synthesis use background image by the synthesis image generating apparatus 107 will be described in detail below. In addition, the synthesis-use background image that has been generated is recorded on the RAM 403 and the recording unit 405 of the synthesis image generating apparatus 107.

The control unit 401 of the synthesis image generating apparatus 107 determines the region in which the synthesis-use background image will be synthesized with the captured image that was acquired during S801. The control unit 401 determines the region in which the synthesis-use background image will be synthesized based on the later position posture information and the position of the display apparatus 103. Specifically, the control unit 401 determines the region of the captured image in which the display-use background image that is displayed on the display apparatus 103 is not shown from among the regions that have been determined as display regions for the background in the captured image as the region in which the synthesis-use background image will be synthesized (S804). The region of the captured image in which the display-use background image that is displayed on the display apparatus 103 is not shown can also be understood to be a region of the captured image corresponding to a region that is more toward the outer side than the image display region of the display apparatus 103. Note that there are cases in which below, the region in which the synthesis-use background image is synthesized with the captured image is referred to as the synthesis region. In addition, the method in which the synthesis image generating apparatus 107 determines the synthesis region will be explained in detail below. In addition, the RAM 403, and the recording unit 405 of the synthesis image generating apparatus 107 record the information showing the synthesis region.

The control unit 401 of the synthesis image generating apparatus 107 synthesizes the synthesis-use background image with the synthesis region of the captured image (S805). More specifically, the control unit 401 substitutes the pixel values for the pixels corresponding to the synthesis region from among the captured image with the pixel values for the pixels of the synthesis-use background image in the region corresponding to this pixel. In addition, the control unit 401 performs this substitution for each pixel in the synthesis region from among the captured image. In addition, the control unit 401 does not perform a substation for the pixel values of the pixels in the synthesis region from among the captured image. By doing so, the control unit 401 generates a synthesis image in which from among the regions that have been determined as the display regions for the background in the captured image, the regions in which the display-use background image is not displayed have been replaced with the synthesis-use background image. In addition, the recording unit 405 of the synthesis image generating apparatus 107 records the synthesis image that has been generated.

Note that the synthesis processing may also be performed per one frame of the in-camera VFX video image. In addition, during the synthesis processing, it may also be made such that the processing proceeds to the next step after the processing for one step has been performed for all of the frames of the in-camera VFX video image. In a case in which the synthesis processing is performed per one frame of the in-camera VFX video image, after the processing for step S801 to step S805 has been performed for the first one frame, the control unit 401 of the synthesis image generating apparatus 107 determines whether or not there has been a command to end the synthesis processing. For example, the determination as to whether or not there has been a command to end the synthesis processing may be determined by whether or not the user has input a command to complete the synthesis processing into the command input unit 408 of the synthesis image generating apparatus 107. In addition, in a case in which there was no command to finish the synthesis processing, the control unit 401 stands by until the next one frame has been transmitted from the camera 101, and upon the next one frame being transmitted by the camera 101, the processing from step 801 to step 805 is performed for the next one frame. In this manner, the processing for step 801 to step 805 is repeated in order for each one frame of the in-camera VFX video image until there is a command to finish the synthesis processing.

Next, the relationship between the display-use background image, the synthesis rendering image, and the synthesis-use background image will be explained. In the present embodiment, it has been explained that the synthesis image generating apparatus 107 generates a synthesis rendering image based on the previous camera parameter and the previous position posture information. In addition, it has also been explained that background image generating apparatus 105 also generates a display-use background image based on the previous camera parameter and the previous position posture information. In this context, in a case in which the camera 101 performs image capturing in the state of the position posture and the camera parameter from the point in time 1 shown in FIG. 5, the display-use background image within the captured image becomes a state in which there are no distortion or changes in magnification due to the position posture or the camera parameter of the camera 101. In this case, discrepancies in position caused by the position posture and the camera parameter of the camera 101 do not occur in the display-use background image in the captured image, and the synthesis rendering image.

However, due to the passage of time necessary to generate the display-use background image, and the like, a time period occurs from the time point 1 during which the previous camera parameter and the previous position posture, which are referenced in the generation of the display-use background image, are detected, until the time point 7 during which the image capturing by the camera 101 begins. If the position posture and the camera parameter of the camera 101 change during this time period, then there are cases in which during the time period 7, the camera 101 captures images in which the display-use background image that has been displayed by the display apparatus 103 is included in the angle of view, and the position posture and the camera parameter for the camera 101 are different than the time period 1. In this case, this becomes a state in which distortions and changes in magnification that are caused by the position posture and camera parameter of the camera 101 occur in the display-use background image that is shown in the captured image according to the occurrence of differences in the position posture and the camera parameter of the camera 101 during the time point 1 and the time point 7. In addition, in this case, a discrepancy in position occurs between the display-use background image within the captured image and the synthesis-rendering image. Additionally, the display-use background image within the captured image is displayed in a region according to the camera parameter and the position posture during the time point 7. Therefore, a discrepancy in position occurs between the display-use background image within the captured image and the synthesis rendering image according to the difference in the camera parameter and the position posture of the camera 101 during the time point 1 and the time point 7.

In this context, the synthesis image generating apparatus 107 suppresses the discrepancies in position between the display-use background image within the captured image and the synthesis-use background image by generating the synthesis-use background image by performing corrections that apply the same distortions and changes in magnification that occurred in the display-use background image within the captured image to the synthesis rendering image.

The method in which the synthesis image generating apparatus 107 generates the synthesis-use background image by correcting the synthesis-rendering image will be explained. The synthesis image generating apparatus 107 uses the Formula (1), and the following Formula (6), which is a formula for perspective projection conversion processing corresponding to the later position posture information and the later camera parameters, and corrects the synthesis rendering image.

$$\begin{matrix}[ Formula 6 ] & \\ {Z}_{c 2} [ \begin{matrix}{u}_{c 2} \\ {v}_{c 2} \\ 1\end{matrix} ] = {A}_{c 2} ( {R}_{c 2} [ \begin{matrix}{X}_{w} \\ {Y}_{w} \\ {Z}_{w}\end{matrix} ] + {T}_{c 2} ) & ( 6 )\end{matrix}$$

The u_{c2}, and v_{c2} of the Formula 6 represent the coordinates for the captured image in a case in which image capturing is performed by the camera 101 with the later camera parameter and a position posture that is represented by the later position posture information.

In addition, the R_{c2} in the Formula (6) is the rotational angle for the camera 101 during the time point 7 shown in FIG. 2 corresponding to the x axis, the y axis, and z axis in the world coordinate system, and the T_{c2} of the Formula (6) is the translation movement amount for the camera 101 during the time point 7 shown in FIG. 2 corresponding to the x axis, the y axis, and z axis in the world coordinate system. R_{c2} in the Formula (6) is derived from the following Formula (7), and T_{c2} in the Formula (6) is derived from the following Formula (8).

$$\begin{matrix}[ Formula 7 ] & \\ {R}_{c 2} = [ \begin{matrix}{β}_{11} & {β}_{12} & {β}_{13} \\ {β}_{21} & {β}_{22} & {β}_{23} \\ {β}_{31} & {β}_{32} & {β}_{33}\end{matrix} ] & ( 7 )\end{matrix}$$

$$\begin{matrix}[ Formula 8 ] & \\ {T}_{c 2} = [ \begin{matrix}{τ}_{1} \\ {τ}_{2} \\ {τ}_{3}\end{matrix} ] & ( 8 )\end{matrix}$$

Each of the constants that are shown in the Formula (7), and the Formula (8) are derived from the later position posture information.

In addition, A_{c2} in the Formula (6) is the later camera parameter that includes the focal distance for the camera 101 during the time point 7 shown in FIG. 5, as is shown in the following Formula (9).

$$\begin{matrix}[ Formula 9 ] & \\ {A}_{c 2} = [ \begin{matrix}{g}_{x} & 0 & {δ}_{x} \\ 0 & {g}_{y} & {δ}_{y} \\ 0 & 0 & 1\end{matrix} ] & ( 9 )\end{matrix}$$

The constants gₓ, and g_{y} of A_{c2} shown in the Formula (9) are the focal distances for the pixel units, and are both derived from the focal distance of the camera 101 that is included in the previous camera parameter and the pixel pitches in the horizontal and vertical directions of the camera 101. In addition, ox and oy that are shown in the Formula (9) are constants for indicating the optical center.

In addition, Z_{c2} in the Formula (6) is a coordinate for the camera coordinate system C2 in the position posture of the camera 101 represented by the later position posture information, and corresponds to the coordinate Z_{w} of the world coordinate system. The coordinates X_{c2}, Y_{c2}, and Z_{c2} of the camera coordinate system C2 that correspond to the coordinates X_{w}, Y_{w}, and Z_{w} in the world coordinate system are derived from the following Formula 10

$$\begin{matrix}[ Formula 10 ] & \\ [ \begin{matrix}{X}_{c 2} \\ {Y}_{c 2} \\ {Z}_{c 2}\end{matrix} ] = {R}_{c 2} [ \begin{matrix}{X}_{w} \\ {Y}_{w} \\ {Z}_{w}\end{matrix} ] + {T}_{c 2} & ( 10 )\end{matrix}$$

The synthesis rendering image is an image in which a 3-dimensional model has been rendered according to the camera parameter and position posture of the virtual camera that have been set based on the previous camera parameter and the previous position posture information. Therefore, the coordinates for the synthesis rendering image can be understood to be represented by u_{c1} and v_{c1} in the same manner as for the Formula 1. In addition, the synthesis image generating apparatus 107 generates the synthesis-use background image by substituting the coordinates for the captured image with coordinates for the synthesis rendering image. Therefore, the coordinates for the synthesis-use background image can be understood to be represented by u_{c2}, and v_{c2} in the same manner as for the captured image. The relationship between the coordinates u_{c1}, and v_{c1} for the synthesis rendering image, and the coordinates u_{c2}, and v_{c2} for the synthesis-use background image from the Formula (1), and the Formula (6) are derived from the following Formula (11).

$$\begin{matrix}[ Formula 11 ] & \\ {Z}_{c 1} [ \begin{matrix}{u}_{c 1} \\ {v}_{c 1} \\ 1\end{matrix} ] = {A}_{c 1} ( {R}_{c 1} {R}_{c 2}^{- 1} ( {A}_{c 2}^{- 1} {Z}_{c 2} [ \begin{matrix}{u}_{c 2} \\ {v}_{c 2} \\ 1\end{matrix} ] - {T}_{c 2} ) + {T}_{c 1} ) & ( 11 )\end{matrix}$$

Z_{c1}, and Z_{c2} from the Formula (11) are derived according to the coordinates u_{c2}, and v_{c2} based on the virtual image display surface including the image display surface for the display apparatus 103, for which the position is already known.

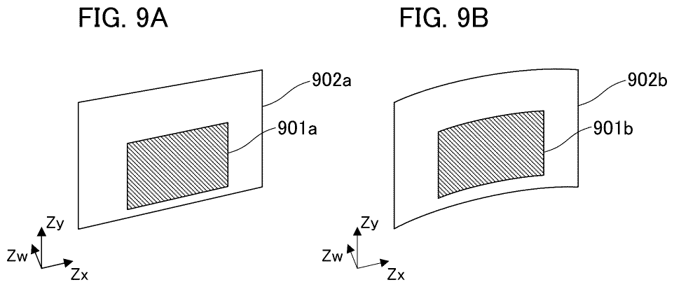

FIG. 9 is a diagram showing an image display surface on the world coordinate system of the image capturing system 100. FIG. 9A shows an image display surface that serves as a plane on the world coordinate system of the image capturing system 100. More specifically, in FIG. 9A, the image display surface 901a of the display apparatus 103 is displayed by a level surface, along with the virtual image display surface 902 being displayed by a level surface. As is shown in FIG. 9A, the virtual image display surface 902a is set so as to include the image display surface 901a of the display apparatus 103. In addition, the image display surface 901a of the display apparatus 103 and the portion from among the virtual image display surface 902a that is more toward the outside than the image display surface 901a of the display surface 103 are consecutive.

FIG. 9B shows an image display surface that serves as a curved surface on the world coordinate system of the image capturing system 100. More specifically, in FIG. 9B, the image display surface 901b of the display apparatus 103 is displayed by a curved surface, along with the virtual image display surface 902b being displayed by a curved surface. As is shown in FIG. 9B, the virtual image display surface 902 is set so as to include the image display surface 901b of the display apparatus 103. In addition, the image display surface 901b of the display apparatus 103, and the portion from among the virtual image display surface 902 that is more toward the outer side than the image display surface 901b of the display apparatus 103 are consecutive. Note that the virtual image display surface 902a and the virtual image display surface 902b are represented by formulas that use one or more of X_{w}, Y_{w}, and Z_{w} as constants. Therefore, it is preferable if the shapes of the image display surface 901a of the display apparatus 103, and the image display surface 901b of the display apparatus 103 are shapes that can be represented by the same formulas that represent the virtual image display surface 902a, and the virtual image display surface 902b.

An example will be explained in which Z_{c1}, and Z_{c2} of the Formula (11) are derived based on a virtual image display surface that includes the image display surface of the display apparatus 103, for which the position is already known. Note that in the example explained below, the image display surface of the display apparatus 103 is a level surface, and the world coordinate system is set such that the origin point for the world coordinate system includes the image display surface of the display apparatus 103. In addition, the direction that is perpendicular to the image display surface of the display apparatus 103 is made the Z axis of the world coordinate system. In this case, the virtual image display surface is represented by the following Formula (12).

$$\begin{matrix}[ Formula 12 ] & \\ {Z}_{w} = 0 & ( 12 )\end{matrix}$$

In addition, the coordinates X_{w}, Y_{w}, and Z_{w} for the world coordinate system that correspond to the coordinates X_{c2}, Y_{c2}, and Z_{c2} for the camera coordinate system C2 are represented by the following Formula (13), which is a variation of the Formula (10).

$$\begin{matrix}[ Formula 13 ] & \\ [ \begin{matrix}{X}_{w} \\ {Y}_{w} \\ {Z}_{w}\end{matrix} ] = {R}_{c 2}^{- 1} ( [ \begin{matrix}{X}_{c 2} \\ {Y}_{c 2} \\ {Z}_{c 2}\end{matrix} ] - {T}_{c 2} ) & ( 13 )\end{matrix}$$

$$\begin{matrix}[ Formula 14 ] & \\ [ \begin{matrix}\begin{matrix}{β}_{13} & {β}_{23}\end{matrix} & {β}_{33}\end{matrix} ] ( [ \begin{matrix}\begin{matrix}{X}_{c 2} \\ {Y}_{c 2}\end{matrix} \\ {Z}_{c 2}\end{matrix} ] - {T}_{c 2} ) = 0 & ( 14 )\end{matrix}$$

In this context, R_{c2} is an orthogonal matrix, and

$${R}_{c 2}^{- 1} = {R}_{c 2}^{T} ,$$

and therefore, the virtual image display surface in the camera coordinate system C2 is represented by the following Formula (14) based on the Formula (12), and the Formula (13).

In addition, the relationship between the coordinates u_{c2}, and v_{c2} of the synthesis-use background image with the coordinates X_{c2}, Y_{c2}, and Z_{c2} of the camera coordinate system C2 is represented in the following Formula (15)

$$\begin{matrix}[ Formula 15 ] & \\ [ \begin{matrix}{X}_{c 2} \\ {Y}_{c 2} \\ {Z}_{c 2}\end{matrix} ] = {A}_{c 2}^{- 1} {Z}_{c 2} [ \begin{matrix}{u}_{c 2} \\ {v}_{c 2} \\ 1\end{matrix} ] & ( 15 )\end{matrix}$$

In this context X_{c2} is represented by the following Formula (1) based on the Formula (15). In addition, Y_{c2} is represented by the following Formula (17).

$$\begin{matrix}[ Formula 16 ] & \\ {X}_{c 2} = \frac{{Z}_{c 2} ( {v}_{c 2} - {δ}_{x} )}{{g}_{x}} & ( 16 )\end{matrix}$$

$$\begin{matrix}[ Formula 17 ] & \\ {Y}_{c 2} = \frac{{Z}_{c 2} ( {v}_{c 2} - {δ}_{y} )}{{g}_{y}} & ( 17 )\end{matrix}$$

In addition, Z_{c2} is represented by the following Formula (18) based on the Formula (14), the Formula (16), and the Formula (17).

$$\begin{matrix}[ Formula 18 ] & \\ {Z}_{c 2} = \frac{{β}_{13} {τ}_{1} + {β}_{23} {τ}_{2} + {β}_{33} {τ}_{3}}{\frac{{β}_{13} ( {x}_{c 2} - {δ}_{x} )}{{g}_{x}} + \frac{{β}_{23} ( {x}_{c 2} - {δ}_{y} )}{{g}_{y}} + {β}_{33}} & ( 18 )\end{matrix}$$

Next, Z_{c2q}, which corresponds to the coordinates u_{c2q}, and v_{c2q} for a predetermined pixel Q in the synthesis-use background image is derived based on the Formula [18]. In addition, X_{c2q}, and Y_{c2q}, which correspond to the coordinates u_{c2q}, and v_{c2q}, are derived by inputting the coordinates u_{c2q}, v_{c2q}, and Z_{c2q} into the Formula (16), and the Formula (17) respectively. In addition, the coordinates X_{c1}, Y_{c1}, and Z_{c1} for the camera coordinate system C1, which correspond to the coordinates X_{c2}, Y_{c2}, and Z_{c2} for the camera coordinate system C2, are represented by the following Formula (19) based on the Formula (5), and the Formula (10).

$$\begin{matrix}[ Formula 19 ] & \\ [ \begin{matrix}{X}_{c 1} \\ {Y}_{c 1} \\ {Z}_{c 1}\end{matrix} ] = {R}_{c 1} {R}_{c 2}^{- 1} ( [ \begin{matrix}{X}_{c 2} \\ {Y}_{c 2} \\ {Z}_{c 2}\end{matrix} ] - {T}_{c 2} ) + {T}_{c 1} & ( 19 )\end{matrix}$$

In addition, the coordinate Z_{c1q}, which corresponds to the coordinates u_{c2q}, and v_{c2q}, is derived by inputting the coordinates u_{c2q}, and u_{c2q} as well as the coordinates X_{c2q}, Y_{c2q}, and Z_{c2q}, which correspond to the coordinates u_{c2q}, and u_{c2q}, into the Formula (19).

As in the above-explained example, the coordinates u_{c1}, and v_{c1}, which are from before the correction, are derived from the coordinates u_{c2}, and v_{c2}, which are from after the correction, using the Formula (11) based on the virtual image display surface that includes the image display screen of the display apparatus 103, for which the position is already known. The synthesis image generating apparatus 107 derives the coordinates u_{c1q}, and v_{c1q} for the synthesis rendering image, which correspond to the coordinates u_{c2q}, and v_{c2q} for the predetermined pixel in the synthesis-use background image, using the Formula (11), and obtains the pixel values for the coordinates u_{c1q}, and v_{c1q} from the synthesis rendering image. In addition, the synthesis image generating apparatus 107 sets the pixel values for the coordinates u_{c1q}, and v_{c1q} as the pixel values for the pre-determined pixel Q of the synthesis-use background image. The synthesis image generating apparatus 107 performs settings for this pixel value for each pixel of the synthesis-use background image. A synthesis-use background image based on the camera parameter and the position posture during the time point 7 shown in FIG. 5, that is, a synthesis-use background image in which discrepancies in position with the display-use background image in the captured image have been suppressed is thereby generated. In this manner, the synthesis image generating apparatus 107 suppresses discrepancies in position (image discrepancies, discrepancies in the translation direction, rotation direction, and compression direction) of the synthesis-use background image corresponding to the display-use background image in the captured image by generating a synthesis-use background image based on the previous position posture information and later position posture information.

Note that the method for deriving the coordinates u_{c1}, and v_{c1} from before the correction from the coordinates u_{c2}, and v_{c2} from after the correction is not limited to the above-explained example. For example, the coordinates u_{c1}, and v_{c1} for before the correction can be obtained from the coordinates u_{c2}, and v_{c2} from after the correction by setting the virtual image display surface that is represented by a formula in which X_{w}, Y_{w}, and Z_{w} are made variables. In addition, in a case in which the virtual image display surface is a curved surface and the like, there are cases in which a plurality of the Z_{c1}, and Z_{c2} shown in the Formula (11) is obtained according to the virtual image display surface. In this case, Z_{c1} and Z_{c2} are uniquely derived by appropriately limiting the range of the virtual image display surface. In addition, there are cases in which the coordinates u_{c1}, and v_{c1} for the synthesis rendering image corresponding to the coordinates u_{c2}, and v_{c2} for the synthesis-use background image correspond to coordinates that are outside of the range of the region that has been rendered. In order to prevent this, in a case in which the synthesis image generating apparatus 107 is generating the synthesis rendering image, rendering may also be performed for a wider range than the image capturing range for the virtual camera that is determined by the previous position posture information and previous camera parameter.

Next, the method in which the synthesis image generating apparatus 107 determines the synthesis region will be explained. The synthesis image generating apparatus 107 detects a region that is more toward the outer side than the image display surface from among the display apparatus 103 by setting a formula that represents the virtual image display surface including the image display surface of the display apparatus 103 on the world coordinate system for the virtual space in the same manner as the method that was used for the generation of the synthesis-use background image.

The method in which the synthesis image generating apparatus 107 detects the region that is more toward the outer side than the image display surface from among the display apparatus 103 will be explained. As was explained above, the camera 101 captures images using the position posture and the camera parameter from the time point 7 that is shown in FIG. 5. Therefore, the coordinates for the captured image can be understood to be represented by the coordinates u_{c2}, and v_{c2} according to the camera coordinate system C2 in the same manner as the synthesis-use background image. The coordinates X_{w}, Y_{w}, and Z_{w} for the world coordinate system that correspond to the coordinates u_{c2}, and v_{c2} are represented by the following Formula (20), which is a variation of the Formula (6).

$$\begin{matrix}[ Formula 20 ] & \\ [ \begin{matrix}{X}_{w} \\ {Y}_{w} \\ {Z}_{w}\end{matrix} ] = {R}_{c 2}^{- 1} ( {A}_{c 2}^{- 1} {Z}_{c 2} [ \begin{matrix}{u}_{c 2} \\ {v}_{c 2} \\ 1\end{matrix} ] - {T}_{c 2} ) & ( 20 )\end{matrix}$$

Z_{c2} shown in the Formula (20) is derived from the coordinates u_{c2}, and v_{c2} based on the formula representing the virtual image display surface in the same manner as the method that was used in the generation of the synthesis-use background image. The synthesis image generating apparatus 107 calculates the coordinates X_{ws}, Y_{ws}, and Z_{ws} that correspond to the coordinates u_{c2s}, and v_{c2s} for a predetermined pixel S of the captured image from the Formula (20). In addition, the synthesis image generating apparatus 107 determines whether or not the coordinates X_{ws}, Y_{ws}, and Z_{ws} that have been calculated are included in the image display surface in the display apparatus 103 from among the virtual image display surface. In addition, in a case in which it has been determined that the coordinates X_{ws}, Y_{ws}, and Z_{ws} are not included in the image display surface in the display apparatus 103 from among the virtual image display surface, the synthesis image generating apparatus 107 sets the pixels for the coordinates u_{c2s}, and v_{c2s} as the pixels for the synthesis region. By performing these settings for each pixel of the captured image, the synthesis image generating apparatus 107 determines the synthesis region.

Note that although in the present embodiment, an example has been explained in which the synthesis image generating apparatus 107 synthesizes a synthesis-use background image with the synthesis region from among the captured image, and does not synthesize the synthesis-use background image with regions that are different than the synthesis region from among the captured image, the present disclosure is not limited thereto. The synthesis image generating apparatus 107 may also synthesize the synthesis-use background image with regions that are different from the synthesis region from among the captured image. More specifically, the synthesis image generating apparatus 107 may also alpha blend the synthesis-use background region with the captured image in regions that are adjacent to the synthesis region and are different than the synthesis region from among the captured image.

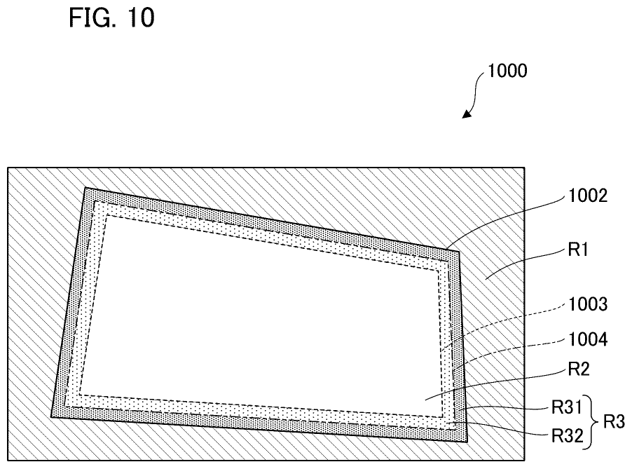

FIG. 10 is a diagram showing contents of an alpha blend of the captured image and the synthesis-use image that is performed in relation to the captured image 1000 corresponding to one frame from among the in-camera VFX video image. The captured image 1000 that is shown in FIG. 10 is a captured image that serves as an in-camera VFX video image that was captured by the camera 101 so as to include the display-use background image that has been displayed on the display apparatus 103 in the angle of view. As is shown in FIG. 10, a synthesis boundary line 1002, a non-synthesis boundary line 1003, a synthesis region R1, and a non-synthesis region R2 are shown in the captured image 1000.

The synthesis boundary line 1002 is a boundary line between the synthesis region R1 and a region that is different than the synthesis region R1 from among the captured image 1000. In the example that is shown in the figure, the region that is more toward the outer side than the synthesis boundary line 1002 from among the captured image 1000 is the synthesis region R1. The synthesis image generating apparatus 107 synthesizes a synthesis-use background image in relation to this synthesis region. More specifically, the synthesis image generating apparatus 107 sets the transparency for the captured image 1000 to 100% in the synthesis region R1, and sets the transparency for the synthesis image to 0% in the synthesis region R1. In addition, in the example in the figures, in the captured image 1000, the display-use background image is not displayed in the synthesis region R1, and is displayed in the region more toward the inner side than the synthesis region R1. Therefore, in the example in the figures, the synthesis boundary line 1002 is a boundary line for the region in which the display-use background image is displayed from among the captured image 1000. In addition, in the example in the figures, the synthesis boundary line 1002 is the boundary line for the image display region of the display apparatus 103 from among the captured image 1000.

The non-synthesis region boundary line 1003 is the boundary line between the non-synthesis region R2, and the region that is different than the non-synthesis region R2 from among the captured image 1000. In the example in the figures, the region that is more toward the inner side than the non-synthesis region boundary line 1003 from among the captured image 1000 is the non-synthesis region R2. In addition, the non-synthesis region R2 is the region with which the synthesis-use background image is not synthesized. The synthesis image generating apparatus 107 sets the transparency of the image 1000 to 0% in the non-synthesis region R2, and sets the transparency of the synthesized image to 100% in the non-synthesis region R2. In addition, in the example shown in the figures, in the captured image 1000, the synthesis-use background image is not displayed in the non-synthesis region R2, and is displayed in the region that is more toward the outer side than the non-synthesis region R2. Therefore, the non-synthesis boundary line 1003 is the boundary line for the region in which the synthesis use background image is displayed from among the captured image 1000.

In addition, an intermediate region R3 and a stage boundary line 1004 are displayed in the captured image 1000. The intermediate region R3 is a region between the synthesis region R1 and the non-synthesis region R2. The synthesis image generating apparatus 107 synthesizes the synthesis-use background image with the intermediate region R3. More specifically, the synthesis image generating apparatus 107 sets the transparency of the synthesis-use image in the intermediate region R3 to a transparency that is higher than the transparency in the synthesis region R1 and lower than the transparency in the non-synthesis region R2. In addition, the synthesis image generating apparatus 107 sets the transparency for the captured image 1000 in the intermediate region R3 to a transparency that is lower than its transparency in the synthesis region R1, and higher than its transparency in the non-synthesis region R2.

In addition, a synthesis-side region R31, and a non-synthesis side region R32 are shown in the intermediate region R3. The synthesis-side region R31 is a region that is on the side that is closer to the synthesis region R1 than to the non-synthesis region R32 from among the intermediate region R3. In other words, there is a shorter distance from the synthesis region R1 to the synthesis-side region R31 than there is in comparison to the non-synthesis side region R32. Note that the distance from the synthesis region R1 means the shortest distance from the synthesis region R1. In addition, the non-synthesis side region R32 is a region on the side that is closer to the non-synthesis region R2 than to the synthesis-side region R31 from among the intermediate region R3. In other words, the non-synthesis side region is a region for which there is a longer distance from the synthesis region R1 to the non-synthesis side region R32 in comparison to the synthesis side region R31. The stage boundary line 1004 is a boundary line between the synthesis-side region R31 and the non-synthesis side region R32 from among the intermediate region R3 in the captured image 1000. In the example shown in the figures, the region that is more toward the outer side than the stage boundary line 1004 from among the intermediate region R3 of the captured image 1000 is the synthesis side region R31, and the region that is more toward the inner side than the stage boundary line 1004 from among the intermediate region R3 in the captured image 1000 is the non-synthesis side region R32.

The synthesis image generating apparatus 107 sets the transparency of the synthesis-use background image in the synthesis-side region R31 to a transparency that is lower than the transparency for the non-synthesis side region R32, along with setting the transparency for the captured image 1000 in the synthesis-side region R31 to a transparency that is higher than the transparency in the non-synthesis side region R32. In other words, the synthesis image generating apparatus 107 sets the transparency for the synthesis-use background image in the non-synthesis side region R32 to a transparency that is higher than the transparency in the synthesis-side region R31, and also sets the transparency for the captured image 1000 in the non-synthesis side region R32 to a transparency that is lower than the transparency in the synthesis side region R31. In this manner, an alpha blend that has been set such that the blending rate for the captured image 1000 with the synthesis-use background image changes in stages in the order of the synthesis region R1, the synthesis side region R31, the non-synthesis side region R32, and the non-synthesis region R2 may be performed in the captured image 1000. In this case a synthesis image is generated in which the boundary lines between the display-use background image and the synthesis-use background image in the captured image 1000 transition smoothly. Therefore, it becomes difficult for the boundary lines between the display-use background image and the synthesis-use background image to stand out in the synthesis image.

Note that the portion of the target in the captured image 1000 for which the transparency is set in the intermediate region R3 is the portion in which the display-use background image is shown from among the captured image 1000. Therefore, the alpha blend in the intermediate region R3 can also be understood as changes in stages of the transparency of the display-use background image that is shown in the captured image 1000 and the transparency of the synthesis-use background image.

Note that although in the present embodiment, an example has been explained in which the synthesis image generating apparatus 107 synthesizes the synthesis-use background image with the captured image, the present disclosure is not limited thereto. For example, the display control apparatus 106 may also display the captured image and the synthesis-use background image on the display apparatus 103 such that the synthesis-use background image is superimposed on the synthesis region of the captured image. Even in this case, it is possible to show the user a captured image and a synthesis-use background image in which discrepancies in position have been suppressed.

### (Variation 1)

Next, variations of the present disclosure will be explained. In the present embodiment, although an example has been explained in which the synthesis image generating apparatus 107 synthesizes the synthesis-use background image with a region that is more toward the outer side than the display-use background image in the captured image, the present disclosure is not limited thereto. The synthesis image generating apparatus 107 may also synthesize the synthesis-use background image with the display region of the display-use background image from among the captured image. In other words, the synthesis image generating apparatus 107 may also synthesize the synthesis-use background image with the image display region of the display apparatus 103 from among the captured image.

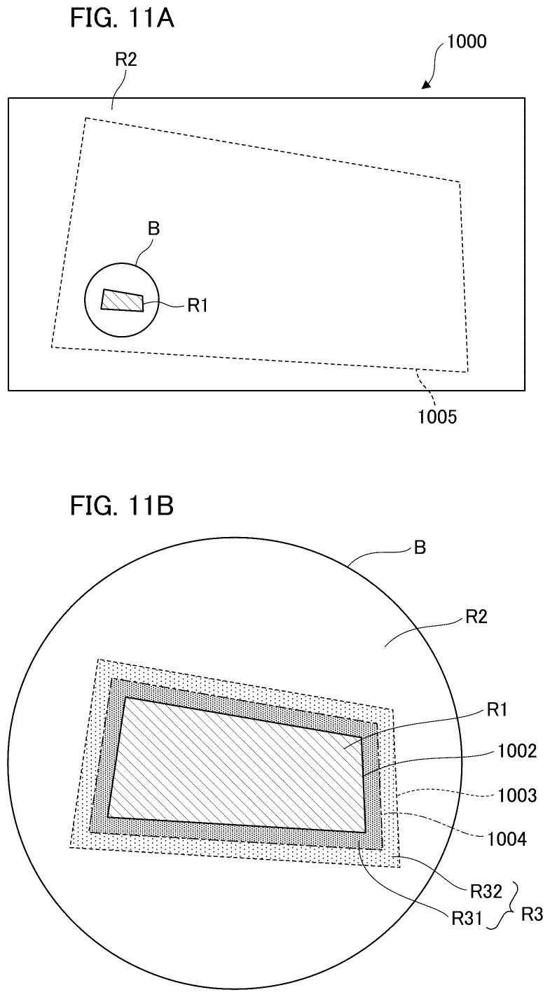

FIG. 11A is a diagram showing the relationship between the captured image 1000 and the synthesis region R1 that serves as a variant 1. A display region boundary line 1005 is shown in the captured image 1000 shown in FIG. 11A. The display region boundary line 1005 is the boundary line for the image display region of the display apparatus 103 from among the captured image 1000. In the example that is shown in the figures, the region that is more toward the inner side than the display region boundary line from among the captured image 1000 is the image display region of the display apparatus 103, and the region that is more toward the outer side than the display region boundary from among the captured image 1000 is the region that is outside of the image display region of the display apparatus 103. In addition, as is shown in FIG. 11A in the captured image 1000, the non-synthesis region R2 is shown on the outer side and the inner side of the display region boundary line 1005. In addition, in the captured image 1000, the synthesis region R1 is shown on the inner side of the display region boundary line 1005. More specifically, in the captured image 1000, the synthesis region R1 is shown inside of a region B, which is a portion of the region in the inner side of the display region boundary line 1005.

In this manner, the synthesis image generating apparatus 107 may also synthesize the synthesis-use background image with the image display region of the display apparatus 103 from among the captured image 1000. In this case, even if a malfunction occurs in the display region of the display-use background image from among the captured image 1000, the synthesis image is synthesized with the region in which the malfunction has occurred, and therefore, it becomes difficult to recognize the malfunction. Note that as the malfunction, for example, a moire pattern that occurs due to a pixel sequence in the image display surface of the display apparatus 103 appearing in the captured image, the unexpected appearance of an unnecessary subject on the camera 101 side rather than the display apparatus 103, and the like are given as examples of the malfunctions. In addition, the synthesis image generating apparatus 107 may also perform an alpha blend of the captured image and the synthesis-use background image in a region that is adjacent to the synthesis region from among the captured image even in a case in which the synthesis-use background image is synthesized with the image display region of the display apparatus 103 from among the captured image 1000.

FIG. 11B is an enlarged diagram of the region B in the captured image 1000 that is shown in FIG. 11A. More specifically, FIG. 11B is a diagram showing the contents of the alpha blend between the captured image and the synthesis-use background image that is performed on the captured image 1000 to serve as a variant 1. A synthesis region R1, a non-synthesis region R2, an intermediate region R3, a synthesis boundary line 1002, a synthesis boundary line 1003, and a stage boundary line 1004 are shown inside of the region B of the captured image 1000.

In the example that is shown in the diagram, the region that is more toward the inner side than the synthesis boundary line 1002 from among the captured image 1000 is the synthesis region R1. The synthesis image generating apparatus 107 sets the transparency of the captured image 1000 to 100% in the synthesis region R1, and sets the transparency of the synthesis image to 0% in the synthesis region R1. In addition, in the example that is shown in the figures, in the captured image 1000, the display-use background image is not displayed in the synthesis region R1, and is displayed in the region that is more toward the outer side than the synthesis region R1. In addition, in the example shown in the figures, the region that is more toward the outer side than the non-synthesis boundary line 1003 from among the captured image 1000 is the non-synthesis region R2. The synthesis image generating apparatus 107 sets the transparency for the captured image 1000 to 0% in the non-synthesis region R2, and sets the transparency for the synthesis image to 100% in the non-synthesis region R2. In addition, in the example shown in the figures, in the captured image 1000, the synthesis-use background image is not displayed in the non-synthesis region R2 and is displayed in the region that is more toward the inner side than the non-synthesis region R2.

In addition, in the example that is shown in the figures, the region that is more toward the inner side than the stage boundary line 1004 from among the intermediate region R3 in the captured image 1000 is the synthesis-side region R31, and the region that is more toward the outer side than the stage boundary line 1004 from among the intermediate region R3 in the captured image 1000 is the non-synthesis side region R32. The synthesis image generating apparatus 107 sets the transparency of the synthesis-use background image in the synthesis-side region R31 to a transparency that is less than the transparency of the non-synthesis side region R32, and also sets the transparency of the captured image 1000 in the synthesis-side region R31 to a transparency that is higher than the transparency for the non-synthesis side region R32. In other words, the synthesis image generating apparatus 107 sets the transparency for the synthesis-use background image in the non-synthesis side region R32 to a transparency that is higher than the transparency in the synthesis side region R31, and also sets the transparency of the captured image 1000 in the non-synthesis side region R32 to a transparency that is lower than the transparency for the synthesis-side region R31. In this manner, in the first variant, an alpha blend may also be performed in which the blending rate has been set such that, the farther away from the outer side a region is in relation to the synthesis region R1 in the captured image 1000, the lower the transparency of the captured image 1000 becomes in this region and the higher the transparency of the synthesis-use background image becomes in this region.

### (Variant 2)

Next, a variant of the synthesis processing (FIG. 8) will be explained. Although an example has been explained in the present embodiment in which the synthesis image generating apparatus 107 suppresses discrepancies in position between the display-use background image in the captured image and the image that is synthesized with the captured image by correcting the synthesis rendering image, the present disclosure is not limited thereto. For example, the synthesis image generating apparatus 107 may also suppress discrepancies in the positions of the display-use background image in the captured image, and the image that is synthesized with the captured image by correcting the captured image to match the image that is synthesized with the captured image.

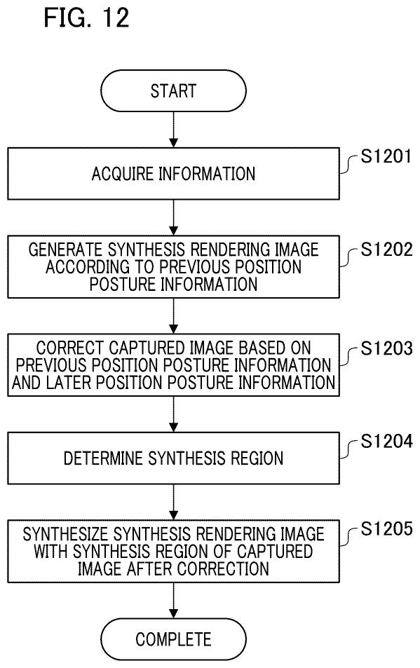

FIG. 12 is a flowchart showing a flow for synthesis processing that serves as a variant 2. During the synthesis processing in the variant 2, the synthesis image generating apparatus 107 corrects the captured image, and synthesizes the synthesis rendering image with the captured image after correction. Not that the processing for step 1201 and step 1202 in the synthesis processing shown in FIG. 12 are the same as the processing for step 801 and step 802 in the synthesis processing shown in FIG. 8. Next, the control unit 401 of the synthesis image generating apparatus 107 corrects the captured image based on the previous position posture information and the later position posture information (S1203). More specifically, the control unit 401 corrects the captured image based on the previous camera parameter, the previous position posture information, the later camera parameter, and the later position posture information. The method in which the synthesis image generating apparatus 107 corrects the captured image will be explained below. The RAM 403 and the recording unit 405 of the synthesis image generating apparatus 107 record the captured image after correction.

The synthesis image generating apparatus 107 determines the region with which the synthesis rendering image will be synthesized from among the captured image after correction (S1204). The method in which the synthesis image generating apparatus 107 determines the region with which the synthesis rendering image will be synthesized from among the captured image after correction will be described. The synthesis image generating apparatus 107 generates the synthesis image by synthesizing the synthesis rendering image with the region that has been determined in step S1205 from among the captured image after correction (S1205). The method for the processing for synthesizing the synthesis rendering image during step S1205 of the synthesis processing shown in FIG. 12 is the same method as the processing for the synthesis of the synthesis-use background image during step S805 of the synthesis processing shown in FIG. 8.

Next, the method in which the synthesis image generating apparatus 107 corrects the captured image will be explained. Note that below, there are cases in which the captured image from before the correction is executed during the synthesis processing is referred to as the captured image before correction, and cases in which the captured image after the correction has been executed during the synthesis processing is referred to as the captured image after correction. As was explained above, the coordinates for the captured image from before correction are represented by u_{c2}, and v_{c2}. In addition, the synthesis image generating apparatus 107 obtains the captured image after correction by substituting the coordinates for the captured image before the correction with the coordinates for the synthesis rendering image. Therefore, the coordinates for the captured image after correction can be understood to be represented by u_{c1}, and v_{c1}, the same as the coordinates for the synthesis rendering image. In this case, the synthesis image generating apparatus 107 uses the following Formula (21), which is a variant of the Formula (11) and corrects the captured image.

$$\begin{matrix}[ Formula 21 ] & \\ {Z}_{c 2} [ \begin{matrix}{u}_{c 2} \\ {v}_{c 2} \\ 1\end{matrix} ] = {A}_{c 2} ( {R}_{c 2} {R}_{c 1}^{- 1} ( {A}_{c 1}^{- 1} {Z}_{c 1} [ \begin{matrix}{u}_{c 1} \\ {v}_{c 1} \\ 1\end{matrix} ] - {T}_{c 1} ) + {T}_{c 2} ) & ( 21 )\end{matrix}$$

Z_{c1}, and Z_{c2} that are shown in the Formula (21) are derived according to the coordinates u_{c1}, and v_{c1} in the same manner as the above-explained example based on the virtual image display surface in the virtual space. The synthesis image generating apparatus 107 derives the coordinates u_{c1i}, and v_{c1i} for a predetermined pixel I of the captured image after correction by using the corresponding coordinates u_{c2i}, and v_{c2i} for the captured image before correction in the Formula (21), and acquires the pixel values for the coordinates u_{c2i}, and v_{c2i} from the captured image before correction. In addition, the synthesis image generating apparatus 107 sets the pixel values for the coordinates u_{c2i}, and v_{c2i} to the pixel values for the pre-determined pixel I from the captured image after correction. The synthesis image generating apparatus 107 generates a captured image after correction in which discrepancies in position with the synthesis rendering image have been suppressed by performing these settings for each of the pixels of the captured image after correction.

Next, the method in which the synthesis image generating apparatus 107 determines the region with which the synthesis rendering image will be synthesized from among the captured image after correction will be explained. Note that below, it is made such that the synthesis rendering image is synthesized with the region that is more toward the outer side than the display use background image from among the captured image after correction, that is, the region that is more toward the outer side than the image display region of the display apparatus 103. The coordinates X_{w}, Y_{w}, and Z_{w} of the world coordinate system, which correspond to the coordinates u_{c1}, and v_{c1} of the captured image after correction, are represented by the following Formula (22), which is a variant of the Formula (1).

$$\begin{matrix}[ Formula 22 ] & \\ [ \begin{matrix}{X}_{w} \\ {Y}_{w} \\ {Z}_{w}\end{matrix} ] = {R}_{c 1}^{- 1} ( {A}_{c 1}^{- 1} {Z}_{c 1} [ \begin{matrix}{u}_{c 1} \\ {v}_{c 1} \\ 1\end{matrix} ] - {T}_{c 1} ) & ( 22 )\end{matrix}$$

Z_{c2} that is shown in the Formula (22) is derived according to the coordinates u_{c1} and v_{c1} in the same manner as the example that was described above based on the virtual image display surface in the virtual space. The synthesis image generating apparatus 107 uses the Formula (22), and calculates the coordinates X_{wj}, Y_{wj}, and Z_{wj} for the world coordinate system corresponding to the coordinates u_{c1j}, and v_{c1j} for the predetermined pixel J of the captured image after correction. In addition, the synthesis image generating apparatus 107 determines whether or not the coordinates X_{wj}, Y_{wj}, and Z_{wj} are included in the region for the image display surface of the display apparatus 103 from among the virtual image display surface. In a case in which it has been determined that the coordinates X_{wj}, Y_{wj}, and Z_{wj} are not included in the region for the image display surface of the display apparatus 103 from among the virtual image display surface, the synthesis image generating apparatus 107 determines that the pixels for the coordinates u_{c1j}, and v_{c1j} are the region with which the synthesis rendering image will be synthesized from among the captured image post correction. In addition, the synthesis image generating apparatus 107 determines the region with which the synthesis rendering image will be synthesized from among the captured image after correction by performing this determination for each pixel of the captured image after correction.

As has been explained above, in the present embodiment, the background image generating apparatus 105 generates the display-use background image according to the position posture for the camera 101 during the first timing (refer to the time point 1 of FIG. 5). In addition, the display control apparatus 106 displays the display-use background image on the display apparatus 103. In addition, the synthesis image generating apparatus 107 generates the synthesis-use background image. In addition, the camera 101 performs image capturing during the second timing (refer to the time point 7 of FIG. 5) during which the display-use background image is displayed on the display apparatus 103. In addition, the synthesis image generating apparatus 107 generates the synthesis-use background image based on the position posture for the camera 101 during the first timing, and the position posture of the camera 101 during the second timing. In this case, position discrepancies between the captured image and the synthesis-use background image are suppressed in cases in which generation is performed of an image in which the image that has been displayed on the display apparatus 103 has been made the background, and generation is performed of a synthesis-use background image that supplements the captured image.

In addition, in the present embodiment, the synthesis image generating apparatus 107 corrects the captured image that has been captured by the camera 101. Therefore, the synthesis image generating apparatus 107 can also be understood as a correcting unit. In addition, the synthesis image generating apparatus 107 corrects the captured image based on the position posture of the camera 101 during the first timing and the position posture of the camera 101 during the second timing. In this case, discrepancies in position between the captured image and the synthesis rendering image are suppressed in a case in which generation is performed of an image in which the image that has been displayed on the display apparatus 103 has been made the background, and generation is performed of a synthesis rendering image that supplements the captured image. In this case, the synthesis rendering image can also be understood to be a second background image.

Note that in the image capturing system 100, the process in which the display-use background image is generated according to the position posture of the camera 101 during the first time can also be understood to be a first generating process. In addition, the process in the image capturing system 100 in which the display-use background image is displayed on the display apparatus 103 can also be understood to be a display control process. In addition, the process in which in the image capturing system 100, the synthesis-use background image is generated can also be understood to be a second generating process. In addition, the process in the image capturing system 100 in which the captured image that has been captured by the camera 101 is corrected can also be understood to be a correcting process.

In addition, the synthesis image generating apparatus 107 determines the position posture of the virtual camera that is positioned in the virtual space according to the position posture of the camera 101 during the first timing. In addition, the synthesis image generating apparatus 107 generates the synthesis rendering image by rendering a 3-dimensional model of the virtual space according to the position posture of the virtual camera that has been determined. In this case, discrepancies in position between the display-use background image that has been generated by the background image generating apparatus 105 and the synthesis rendering image are suppressed.

In addition, the synthesis image generating apparatus 107 generates the synthesis-use background image by correcting the synthesis rendering image based on the difference between the position posture of the camera 101 during the first timing and the position posture of the camera 101 during the second timing. In this case, discrepancies in position between the captured image and the synthesis-use background image are suppressed even in a case in which a difference occurs between the position posture of the camera 101 during the first timing and the position posture of the camera 101 during the second timing.

In addition, the correction of the synthesis rendering image includes performing perspective projection conversion processing according to the already known position information of the display apparatus 103 on the synthesis rendering image. In this case, the correction of the synthesis rendering image is performed according to the position of the display apparatus 103.

In addition, the synthesis image generating apparatus 107 synthesizes the captured image that was captured by the camera 101 during the second timing with the synthesis use background image. Therefore, the synthesis image generating apparatus 107 can also be understood to be a synthesis unit. In this case, it becomes difficult for the user to recognize the display contents of the regions with which the synthesis use background image has been synthesized from among the captured image in comparison with a configuration in which the captured image is not synthesized with the synthesis-use background image.

In addition, the synthesis image generating apparatus 107 determines the synthesis region in the captured image based on the position posture of the camera 101 during the second timing and the already known position information for the display apparatus 103, and synthesizes the synthesis use background image with the synthesis regions of the captured image that have been determined. In this case, discrepancies in the region with which the synthesis-use background image is synthesized from among the captured image according to the relationship between the position posture of the camera 101 and the position of the display apparatus 103 are suppressed.

In addition, the synthesis region is the region of the captured image corresponding to a region more toward the outer side than the image display region of the display apparatus 103. In this case, it is possible to provide an in-camera VFX video image that has been generated by image capturing that includes the region more toward the outer side than the image display region of the display apparatus 103 in the angle of view.

In addition, the synthesis image generating apparatus 107 synthesizes the captured image and the synthesis-use background image such that in the intermediate regions of the captured image, the ratio of the transparency of the captured image and the transparency of the synthesis-use background image gradually changes according to the distance from the synthesis region (refer to FIG. 10). In this case, it becomes difficult to distinguish the borders between the display-use background image from among the captured image and the synthesis-use background image.

In addition, the synthesis image generating apparatus 107 determines the synthesis region based on a parameter relating to the optical characteristics of the camera 101. For example, the focal distance is given as an example of the parameter relating to the optical characteristics of the camera 101. In this case, discrepancies in the regions from among the captured image in which the synthesis-use background image is synthesized are suppressed according to the optical characteristics of the camera 101.

In addition, the difference in time between the first timing and the second timing is less than one frame of the captured image by the camera 101. In this case, a synthesis-use background image in which discrepancies in position with the display-use background image within the captured image have been suppressed is generated for each frame of the in-camera VFX video image. Therefore, the occurrence of captured images in which discrepancies in position with the synthesis-use background image have not been suppressed is prevented.

In addition, the recording unit 208 of the camera 101 records information representing the position posture of the camera 101 during the first timing, and information representing the position posture of the camera 101 during the second timing. In this case, it is possible to provide the previous position posture information and the later position posture information to the synthesis image generating apparatus 107 regardless of the timing at which the synthesis-use background image is generated.

In addition, the synthesis image generating apparatus 107 generates the synthesis-use background image based on the focal distance for the camera 101 during the first timing and the focal distance for the camera 101 during the second timing. In this case, discrepancies in position between the display-use background image and the synthesis-use background image in the captured image are suppressed even in cases in which the focal distance of the camera 101 differs during the first timing and the second timing.

Note that the method that suppresses the discrepancies in position between the captured image and the synthesis-use background image is not limited to the example that has been described above. For example, the synthesis image generating apparatus 107 may also correct the image according to high frequency components in the image based on the frequency of regions in which minute changes in shades occur in the image corresponding to a high frequency, while the frequency of regions in which smooth changes in shades occur in the image corresponding to a low frequency. One example of the synthesis image generating apparatus 107 correcting the image according to high frequency components of the image will be explained. There are cases in which minute changes in shades occur in the display-use background image within the captured image and the synthesis-use background image. In this case, it is possible to specify the positional relationship between the display-use background image in the captured image and the synthesis-use background image from the relationship between the distribution of high frequency components in the display-use background image in the captured image and the distribution of high frequency components in the synthesis-use background image. In this context, the synthesis image generating apparatus 107 detects the distribution of the high frequency components in the display-use background image in the captured image, and the distribution of the high frequency components in the synthesis-use background image. In addition, the synthesis image generating apparatus 107 corrects at least one of the captured image and the synthesis-use background image so as to suppress discrepancies in position between the display-use background image in the captured image and the synthesis-use background image based on the detection results. In other words, the synthesis image generating apparatus 107 corrects the relative positions of the captured image and the synthesis-use background image according to the detected results. Even in such a case, discrepancies in position between the display-use background image in the captured image and the synthesis-use background image are suppressed. In addition, in this case, the synthesis image generating apparatus 107 can also be understood as a position correcting unit.

In addition, although an example has been explained in the present embodiment in which the image capturing system 100 acquires the previous camera parameter and the later camera parameter for each frame of the in-camera VFX video, the present disclosure is not limited thereto. For example, there are cases in which the camera parameter is fixed during the capturing of the in-camera VFX video. In this case, there is one single camera parameter in the in-camera VFX video regardless of the frame, and therefore, it is sufficient if this single camera parameter is acquired by the image capturing system 100.

In addition, although an example has been explained in the present embodiment in which the synthesis boundary between the display-use background image and the synthesis-use background image is an outer peripheral end of the image display region in the display apparatus 103 from among the captured image, the present disclosure is not limited thereto. For example, the synthesis boundary between the display-use background image and the synthesis-use background image may also be a contour portion of a subject positioned in a pre-determined region more toward the side of the camera 101 than the display apparatus 103 inside of the image display region of the display apparatus 103 from among the captured image. In this case, the background image generating apparatus 105 may also decrease the load associated with the necessary rendering and correction for generating the image by generating the background rending image and the display-use background image by limiting the synthesis region from among the captured image to inside of image display region of the display apparatus 103 that has been determined.

In addition, although an example has been explained in the present embodiment in which the camera parameter that is acquired by the image capturing system 100 is the focal distance, the present disclosure is not limited thereto. For example, information for distortions caused by the optical system 204 of the camera 101 is given as an example of the camera parameter that is acquired by the image capturing system 100. Distortions caused by the optical system 204 are barrel-type distortions, pincushion distortions, and the like, and there are cases in which when the focal distance of the camera 101 changes, these barrel-type distortions, pin cushion distortions, and the like also change. In this case, it becomes such that the information for distortions caused by the optical system 204 is used as the camera parameter in the generation of the captured image by substituting the A_{c1} shown in the Formula (4), and the A_{c2} shown in the Formula (9) into a formula that includes the information for the distortions caused by the optical system 204. In addition, by using the information for distortions caused by the optical system 204 during the generation of the image, even in a case in which a difference occurs in the distortions caused by the optical system 204 between the time point 1 (refer to FIG. 5) and the time point 7, the discrepancies in position between the display-use background image in the captured image and the synthesis-use background image are suppressed. In this manner, the synthesis image generating apparatus 107 corrects at least one of the captured image and the synthesis-use background image based on a parameter relating to the optical characteristics of the camera 101. In this case, the discrepancies in position between the display-use background image in the captured image and the synthesis-use background image are suppressed even in a case in which the optical properties of the camera 101 change according to the progression of time. In addition, in this case, the synthesis image generating apparatus 107 may also be understood as an optical correcting unit. In addition, the focal distance of the camera 101, distortions caused by the optical system 204 of the camera 101, and the like are given as examples of parameters relating to the optical characteristics of the camera 101.

In addition, although an example has been explained in the present embodiment in which during the generation of the display-use background image, the time difference between the detection timing for the position posture of the camera 101 that becomes the reference (the time point 1 of FIG. 5) and the timing at which image capturing is begun (the time point 7 of FIG. 5) is less than one frame, the present disclosure is not limited thereto. The difference in time between the time point 1 and the time point 7 that are shown in FIG. 5 may also be one frame, and may also exceed one frame. Even in this case, the discrepancies in position between the display-use background image in the captured image and the synthesis-use background image caused by differences that occur during the generation of the display-use background image between the position posture of the camera 101 at the detection timing of the position posture of the camera 101 that will become the reference and the timing at which the image capturing is begun are suppressed.

Note that in a case in which the difference in time between the time point 1 and the time point 7 that are shown in FIG. 5 is a multiple of one frame, the timing at which the image capturing is begun will match the detection timing of the position posture for the camera 101 that will become the reference during the generation of the display-use background image that makes the next frame after the first frame the target. In this case, the later position posture that is used in the generation of the synthesis-use background image for which the first frame is the target, and the previous position posture information that is used in the generation of the display-use background image for which the next frame is the target are the same information and therefore, it is sufficient if processing is performed on just one of these pieces of information.

In addition, for example, the synthesis image generating apparatus 107 may also compare the display-use background image in the captured image and the synthesis-use background image, and correct one of the display-use background image in the captured image and the synthesis-use background image according to the results of the comparison. For example, the synthesis image generating apparatus 107 may also translationally move the entirety of the synthesis-use background image such that the difference between a region of the display-use background image in the captured image and the corresponding synthesis use image becomes smaller. In this case, residual discrepancies such as discrepancies in the background image resulting from the detection precision of the position posture of the camera 101 by the position posture detecting apparatus 102 are suppressed, and therefore, discrepancies in position between the display-use background image in the captured image and the synthesis-use background image are further suppressed.

In addition, although an example has been explained in the present embodiment in which the camera 101 records the captured image, the previous position posture information, the later position posture information, the previous camera parameter, and the later camera parameter, the present disclosure is not limited thereto. The captured image, the previous position posture, the later position posture, the previous camera parameter, and the later camera parameter may also be stored on any apparatus in the image capturing system 100. In addition, the captured image, the previous position posture information, the later position posture information, the previous camera parameter, and the later camera parameter may also each be stored on different apparatuses in the image capturing system 100.

In addition, although an explanation has been given in the present embodiment in which the synthesis image generating apparatus 107 performs the generation of the synthesis-use background image and the generation of the synthesis image after the image capturing of the in-camera VFX video image has been completed, the present disclosure is not limited thereto. The synthesis image generating apparatus 107 may also perform the generation of the synthesis-use background image and the generation of the synthesis image parallelly with the image capturing of the in-camera VFX video image.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to suppress discrepancies in positions between a captured image and a background image in a case in which generation of an image in which the background has been made an image displayed on a display apparatus, and generation of a background image to supplement the captured image are performed.

This application claims the benefit of Japanese Patent Application No. 2024-177658, filed Oct. 10, 2024, which is hereby incorporated by reference herein in its entirety.

What is claimed is:

1. An image capturing system configured to perform image capturing in which an image that has been displayed on a display apparatus has been made a background, the image capturing system comprising:
at least one memory storing instructions; and
at least one processor executing the stored instructions causing the image capturing system to:
generate a first background image according to a position posture of an image capturing apparatus during a first timing;
display the first background image on the display apparatus; and
generate a second background image corresponding to the first background image; wherein
the image capturing apparatus performs image capturing during a second timing during which the first background image is displayed on the display apparatus; and
wherein the processor further executes the stored instructions causing the image capturing system to:
generate the second background image based on the position posture of the image capturing apparatus during the first timing, and a position posture of the image capturing apparatus during the second timing.

2. The image capturing system according to claim 1, wherein the at least one processor further executes the stored instructions causing the image capturing system to:
determine a position posture of a virtual camera positioned in a virtual space according to the position posture of the image capturing apparatus during the first timing, and generate a rendering image by rendering a 3-dimensional model of the virtual space according to the position posture of the virtual camera that has been determined.

3. The image capturing system according to claim 2, wherein the at least one processor further executes the stored instructions causing the image capturing system to:
generate the second background image by correcting the rendering image based on a difference between the position posture of the image capturing apparatus during the first timing and the position posture of the image capturing apparatus during the second timing.

4. The image capturing system according to claim 3, wherein the correcting includes performing perspective projection conversion processing on the rendering image according to already known position information for the display apparatus.

5. The image capturing system according to claim 1, wherein the at least one processor further executes the stored instructions causing the image capturing system to:
synthesize a captured image that the image capturing apparatus has captured during the second timing with the second background image.

6. The image capturing system according to claim 5, wherein the at least one processor further executes the stored instructions causing the image capturing system to:
determine a synthesis region in the captured image based on the position posture of the image capturing apparatus during the second timing and already known position information for the display apparatus, and synthesize the second background image with the synthesis region of the captured image that has been determined.

7. The image capturing system according to claim 6, wherein the synthesis region is a region of the captured image that corresponds to a region more toward an outer side than an image display region of the display apparatus.

8. The image capturing system according to claim 6, wherein in the region of the captured image, there is the synthesis region, a non-synthesis region with which the second background image is not synthesized, and an intermediate region that is a region between the synthesis region and the non-synthesis region; and
wherein the at least one processor further executes the stored instructions causing the image capturing system to:
synthesize the captured image with the second background image such that a ratio in the intermediate region of the captured image of a transparency of the captured image and a transparency of the background image changes in stages according to a distance from the synthesis region.

9. The image capturing system according to claim 6, wherein the at least one processor further executes the stored instructions causing the image capturing system to:
determine the synthesis region based on a parameter relating to optical characteristics of the image capturing apparatus.

10. The image capturing system according to claim 1, wherein a difference in time between the first timing and the second timing is less than one frame of an image captured by the image capturing apparatus.

11. The image capturing system according to claim 1, wherein the at least one processor further executes the stored instructions causing the image capturing system to:
record information showing the position posture of the image capturing apparatus during the first timing, and information showing the position posture of the image capturing apparatus during the second timing.

12. The image capturing system according to claim 1, wherein the at least one processor further executes the stored instructions causing the image capturing system to:
correct at least one of the captured image and the second background image based on a parameter relating to optical characteristics of the image capturing apparatus.

13. The image capturing system according to claim 1, wherein the at least one processor further executes the stored instructions causing the image capturing system to:
correct relative positions of the captured image and the second background image based on high frequency components of the captured image and high frequency components of the second background image.

14. The image capturing system according to claim 1, wherein the at least one processor further executes the stored instructions causing the image capturing system to:
generate the second background image based on a focal distance of the image capturing apparatus during the first timing and a focal distance of the image capturing apparatus during the second timing.

15. An image capturing system configured to perform image capturing in which an image that has been displayed on a display apparatus has been made a background, the image capturing system comprising:
at least one memory storing instructions; and
at least one processor executing the stored instructions causing the image capturing system to:
generate a first background image according to a position posture of an image capturing apparatus during a first timing;
display the first background image on the display apparatus;
generate a second background image corresponding to the first background image; and
correct a captured image that has been captured by the image capturing apparatus; wherein
the image capturing apparatus captures the captured image at a second timing during which the first background image is displayed on the display apparatus;
wherein the at least one processor further executes the stored instructions causing the image capturing system to:
generate the second background image based on the position posture of the image capturing apparatus during the first timing; and
correct the captured image based on the position posture of the image capturing apparatus during the first timing and a position posture of the image capturing apparatus during the second timing.

16. A control method for an image capturing system configured to perform image capturing in which an image that has been displayed on a display apparatus has been made a background, the control method comprising:
generating a first background image according to a position posture of an image capturing apparatus during a first timing;
displaying the first background image on the display apparatus; and
generating a second background image corresponding to the first background image; wherein
the image capturing apparatus performs image capturing during a second timing during which the first background image is displayed on the display apparatus; and
during the generating of the second background image, the second background image is generated based on the position posture of the image capturing apparatus during the first timing, and a position posture of the image capturing apparatus during the second timing.

17. A control method for an image capturing system configured to perform image capturing in which an image that has been displayed on a display apparatus has been made a background, the control method comprising:
generating a first background image according to a position posture of an image capturing apparatus during a first timing;
displaying the first background image on the display apparatus;
generating a second background image corresponding to the first background image; and
correcting a captured image that has been captured by the image capturing apparatus; wherein
the image capturing apparatus captures the captured image at a second timing during which the first background image is displayed on the display apparatus;
during the generating of the second background image, the second background image is generated based on the position posture of the image capturing apparatus during the first timing; and
during the correcting of the captured image, the captured image is corrected based on the position posture of the image capturing apparatus during the first timing and the position posture of the image capturing apparatus during the second timing.

18. A non-transitory storage medium storing a program of an image capturing system, causing a computer to perform each step of a method for the image capturing system, the method comprising:
generating a first background image according to a position posture of an image capturing apparatus during a first timing;
displaying the first background image on the display apparatus; and
generating a second background image corresponding to the first background image; wherein
the image capturing apparatus performs image capturing during a second timing during which the first background image is displayed on the display apparatus; and
during the generating of the second background image, the second background image is generated based on the position posture of the image capturing apparatus during the first timing, and a position posture of the image capturing apparatus during the second timing.

19. A non-transitory storage medium storing a program of an image capturing system, causing a computer to perform each step of a method for the image capturing system, the method comprising:
generating a first background image according to a position posture of an image capturing apparatus during a first timing;
displaying the first background image on the display apparatus;
generating a second background image corresponding to the first background image; and
correcting a captured image that has been captured by the image capturing apparatus; wherein
the image capturing apparatus captures the captured image at a second timing during which the first background image is displayed on the display apparatus;
during the generating of the second background image, the second background image is generated based on the position posture of the image capturing apparatus during the first timing; and
during the correcting of the captured image, the captured image is corrected based on the position posture of the image capturing apparatus during the first timing and a position posture of the image capturing apparatus during the second timing.
